(19) United States
(12) Patent Application Publication
(10) Pub. No.: US 2015/0060277 A1
(43) Pub. Date: Mar. 5, 2015

(54) Nanopore Control With Pressure and Voltage

(71) Applicants: President and Fellows of Harvard College, Cambridge, MA (US); Peking University, Beijing (CN)

(72) Inventors: Jene A. Golovchenko, Lexington, MA (US); Bo Lu, Cambridge, MA (US); David P. Hoogerheide, Gaithersburg, MD (US); Dapeng Yu, Beijing (CN); Qing Zhao, Beijing (CN)

(73) Assignees: PEKING UNIVERSITY, Beijing (CN); PRESIDENT AND FELLOWS OF HARVARD COLLEGE, Cambridge, MA (US)

(21) Appl. No.: 14/485,628

(22) Filed: Sep. 12, 2014

Related U.S. Application Data
(63) Continuation-in-part of application No. PCT/CN2012/000840, filed on Jun. 15, 2012.

(30) Foreign Application Priority Data
Mar. 13, 2012 (CN) 201210065833.7

(51) Int. Cl. G01N 27/447; G01N 27/453

(52) U.S. Cl. CPC G01N 27/44765; G01N 27/44791; G01N 27/453
USPC 204/453; 204/604

(57) ABSTRACT

There is provided a nanopore system including a nanopore in a support structure. A first reservoir is in fluidic connection with the nanopore and a second reservoir is in fluidic connection with the nanopore. The support structure separates the first and second reservoirs. A pressure source is connected to one of the first and second reservoirs to apply an external pressure to one of the first and second reservoirs. A voltage source is connected between the first and second reservoirs to apply a voltage bias between the first and second reservoirs, across the nanopore. This system enables a method for analysis of species in solution, wherein there is provided to the nanopore a fluidic solution that includes a species for translocation through the nanopore, with an external pressure applied to the species in fluidic solution and a voltage bias applied across the nanopore.

### CROSS-REFERENCE TO RELATED APPLICATIONS

This is a continuation-in-part of co-pending International Application PCT/CN2012/000840, having an international filing date of Jun. 15, 2012, the entirety of which is hereby incorporated by reference. This application also claims the benefit of Chinese Patent Application No. 201210065833.7, filed Mar. 13, 2012, the entirety of which is hereby incorporated by reference.

### STATEMENT REGARDING FEDERALLY SPONSORED RESEARCH

This invention was made with Government support under Contract No. R01HG003703 awarded by the NIH. The Government has certain rights in the invention.

### BACKGROUND

This invention relates generally to species detection and analysis with a nanopore, and more particularly relates to configurations for controlling the environment of a nanopore that is arranged to detect species in the vicinity of and translocating through the nanopore.

The detection, characterization, identification, and sequencing of a wide range of species such as molecules, and particularly biomolecules, e.g., polynucleotides such as the biopolymer nucleic acid molecules DNA, RNA, and peptide nucleic acid (PNA), as well as proteins, and other biological molecules, is an important and expanding field of research. There is currently a great need for processes that can determine the hybridization state, configuration, monomer stacking, charge state, and sequence of polymer molecules in a rapid, reliable, and inexpensive manner. Advances in medicine, particularly in the area of gene therapy, development of new pharmaceuticals, and matching of appropriate therapy to patient, are in large part dependent on such processes.

In one process for nanopore-based detection and analysis of species that are molecules, it has been shown that molecules such as nucleic acids and proteins can be directed to and transported through a biological, natural, or solid-state aperture having nano-scale dimensions, that is, a nano-scale pore, or nanopore, and that characteristics of the molecule, including its identification, its state of hybridization, its interaction with other molecules, charge state and its sequence, i.e., the linear order of the monomers of which a polymer is composed, can be discerned by interaction of the species with the nanopore.

In one particularly popular configuration for molecular analysis with a nanopore, the flow of ionic current through a nanopore is monitored as a liquid ionic solution, and molecules to be studied that are provided in the solution, traverse the nanopore. As molecules in the ionic solution translocate through the nanopore, the molecules at least partially block flow of the liquid solution, and the ions in the solution, through the nanopore. This blockage of ionic solution can be detected as a reduction in measured ionic current through the nanopore. With a configuration that imposes single-molecule traversal of the nanopore, this ionic blockage measurement technique has been demonstrated to successfully detect individual molecular nanopore translocation events.

Conventionally, ionic current flow through a nanopore is achieved by the imposition of an electrical voltage bias-induced electric field across the nanopore. The voltage bias is typically employed not only to produce an ionic current through a nanopore but also to induce electrically charged species to approach and traverse the nanopore. In this way, there can be provided an electrophoretic force in the neighborhood of the nanopore and in the nanopore itself to drive electrically-charged species toward and through a nanopore. As a species traverses the nanopore, the ionic current flow through the nanopore that is produced by the voltage bias is sensitive to the presence and nature of the species. The applied voltage bias thereby is responsible for all of the processes of species capture in the neighborhood of a nanopore, translocation of species through the nanopore, and detection of species at the nanopore.

With this voltage-based control technique, DNA single-molecule detection based on solid-state nanopore devices has become one of the most promising candidates for third generation fast and cost-effective human gene sequencing, which aims to achieve one-person genome sequencing in 24 hours at a cost of less than 1000 US dollars. The electrophoretic driving of molecules to translocate through a nanoscale pore in an ionic solution has been demonstrated to enable single-molecule detection and analysis, with the detected signal characteristic corresponding to molecular structure information; as a result, there can be directly characterized thousands of base pairs of a single stranded DNA molecule. This avoids the need for sample amplification or labeling, making fast and low cost DNA sequencing possible. In a typical setup, an external voltage bias provides an electric field that drives a DNA strand through a nanopore. Each measured drop in ionic current through the nanopore corresponds to a DNA translocation event, described by the ionic current blockage (the ionic current drop magnitude) and event duration (the corresponding duration of ionic current drop). This ionic current blockage and event time duration corresponds to the biological information of the translocated DNA molecule.

It is found that the multiple functions for which an applied voltage bias at a nanopore is responsible can strongly constrain the ability to independently control each function. For example, very short, highly-charged species such as DNA molecules can traverse a nanopore so quickly under an electrophoretic driving force that their length and identity cannot be resolved, or in the worst case, their presence cannot even be detected. Currently, DNA translocation speed through a nanopore is too fast to meet the bandwidth requirements for resolving individual nucleotides. Translocation speed can be decreased with reduced applied voltage, but at a relatively low applied voltage the rate of capture of species at a nanopore is significantly reduced, and there is produced a smaller electronic detection signal. This reduced signal results in degradation of the signal-to-noise ratio, and a correspondingly reduced ability to make precise signal measurements. Aside from these limitations, species having little or no electrical charge are not even attracted to an uncharged nanopore and hence cannot be detected or analyzed by such a nanopore. As a result, nanopore-based species detection and analysis have been largely limited to study of electrically-charged species at an intermediate voltage regime that is not optimized for any of the functions required of the nanopore voltage control.

### SUMMARY OF THE INVENTION

To overcome these severe limitations in nanopore systems, there is herein provided a nanopore system including a nanopore in a support structure. A first reservoir is in fluidic connection with the nanopore and a second reservoir is in fluidic connection with the nanopore. The support structure separates the first and second reservoirs. A pressure source is connected to one of the first and second reservoirs to apply an external pressure to one of the first and second reservoirs. A voltage source is connected between the first and second reservoirs to apply a voltage bias between the reservoirs, across the nanopore.

This system enables a method for analysis of species in solution, wherein there is provided to the nanopore a fluidic solution that includes a species for translocation through the nanopore. There is applied to the species in fluidic solution an external pressure, and there is applied across the nanopore an electrical voltage bias that produces an electric field across the nanopore.

With this configuration of the nanopore system there can be decoupled the operation of an applied voltage as both a nanopore translocation force and a nanopore translocation detection transduction element. Pressure-induced hydrodynamic forces depend on the shape and size of a translocating species, not the electrical charge of the species. As a result, nanopores configured with both pressure and voltage bias control can characterize very small molecules, such as proteins, and species with very small electrical charges, as well as species in a variety of shapes as well as sizes. Other features and advantages will be apparent from the description below and accompanying figures, and from the claims.

### BRIEF DESCRIPTION OF THE DRAWINGS

FIG. 1 is a schematic view of an example nanopore system including both pressure and voltage control;

FIG. 2 is a plot of force on species at a nanopore as a function of radial position across the nanopore for an externally applied pressure, an applied voltage bias, and a combination of externally applied pressure and applied voltage bias;

FIG. 3 is a plot of net force towards a nanopore as a function of distance from the nanopore center for a combination of an externally applied pressure and an applied voltage bias;

FIG. 4A is a schematic view of and a corresponding plot of force on a molecule at a nanopore for a combination of externally applied pressure and applied voltage bias that disallow motion of the molecule to the access region of the nanopore;

FIG. 4B is a schematic view of and a corresponding plot of force on a molecule at a nanopore for a combination of externally applied pressure and applied voltage bias that physically trap a molecule at the access region of the nanopore;

FIG. 5A is a plot of measured nanopore conductance as a function of time for the molecular motion in FIG. 4A;

FIG. 5B is a plot of measured nanopore conductance as a function of time for the molecular motion in FIG. 4B;

FIG. 5C is a plot of measured nanopore conductance as a function of time for two nanopore translocation events by a molecule;

FIG. 5D is a schematic view of and a corresponding plot of force on a molecule at a nanopore for a combination of externally applied pressure and applied voltage bias that enable the nanopore translocation events of FIG. 5C;

FIG. 6 is a schematic view of the geometric parameters of an example solid state nanopore for modeling forces on the nanopore;

FIGS. 7A-7B are plots of nanopore conductance as a function of nanopore radius and length for a DNA molecule translocating the nanopore and having charge density of 1.6 e⁻/bp and 1.8 e⁻/bp, respectively;

FIG. 8 is a plot of charge density of a DNA molecule at a nanopore for pairs of nanopore radius and length values as set by an example iterative computation method;

FIG. 9A is a density histogram of ionic current flow blockage events by DNA molecules through a nanopore as a function of event duration through the nanopore for nanopore translocation controlled by an applied voltage bias;

FIG. 9B is a first density histogram of ionic current flow blockage events by DNA molecules through a nanopore as a function of event duration through the nanopore for nanopore translocation controlled by an applied voltage bias and an externally applied pressure;

FIG. 9C is an unfolded event duration histogram for the density histograms of FIGS. 9A-9B;

FIG. 10A is a second density histogram of ionic current flow blockage events by DNA molecules through a nanopore as a function of event duration through the nanopore for nanopore translocation controlled by an applied voltage bias and an externally applied pressure;

FIG. 10B is an unfolded event duration histogram for the density histogram of FIG. 10A and for a histogram for DNA molecules of a second length, demonstrating that the two distinct-length DNA molecules can be discriminated;

FIG. 11 is a plot of the measured charge density of a DNA molecule as a function of liquid solution pH for the nanopore system of FIG. 1;

FIG. 12A is a plot of measured ionic current flow through a nanopore as a function of time for a single attempt by a molecule to translocate a nanopore;

FIG. 12B is a plot of measured ionic current flow through a nanopore as a function of time for multiple attempts by a molecule to translocate a nanopore;

FIG. 12C is a plot of measured ionic current flow through a nanopore as a function of time for single and multiple attempts by a molecule to translocate a nanopore;

FIG. 12D is a plot of measured ionic current flow through a nanopore as a function of time for single and multiple attempts by a molecule to translocate a nanopore, showing complex time-dependencies;

FIG. 13A is an interval histogram for attempts by a 615 bp dsDNA molecule to translocate a nanopore under an opposing applied voltage bias of −100 mV and under a range of externally applied pressures, with the inset pictorially representing the threshold crossing algorithm used to generate the interval histogram;

FIG. 13B is a comparison of the event duration histogram of single-attempt current blockage events and the last attempt of multiple-attempt current blockage events from FIG. 13A for an externally applied pressure of 1.87 atm;

FIG. 13C is an interval histogram demonstrating the time intervals for 3.27 kbp dsDNA molecule capture and translocation attempts under opposing voltage bias of −100 mV and externally applied pressure of 0.865 atm;

FIG. 13D is a histogram of long-event durations for the interval histogram of FIG. 13C;

FIG. 14A is a logarithmic ionic current blockage event duration histogram for 615 bp dsDNA at an opposing voltage bias of −100 mV and an externally applied pressure of 1.64 atm and 1.70 atm;

FIG. 14B is a logarithmic ionic current blockage event duration histogram for 615 bp dsDNA at an opposing voltage bias of −100 mV and an externally applied pressure of 1.76 atm;

FIG. 14C is a schematic interpretation of the event duration histograms of FIGS. 14A-14B and a calculation of failed translocations used in the calculation of average trapped time of successful translocation events;

FIG. 14D is a logarithmic event duration histogram for 3.27 kbp dsDNA showing successful and failed translocations;

FIG. 15A is a plot of the percentage of unsuccessful translocations as a function of pressure for a 615 bp dsDNA molecule at an opposing voltage bias of −100 mV; and

FIG. 15B is a plot of the average escape time of 615 bp dsDNA molecules that successfully translocate a nanopore.

### DETAILED DESCRIPTION

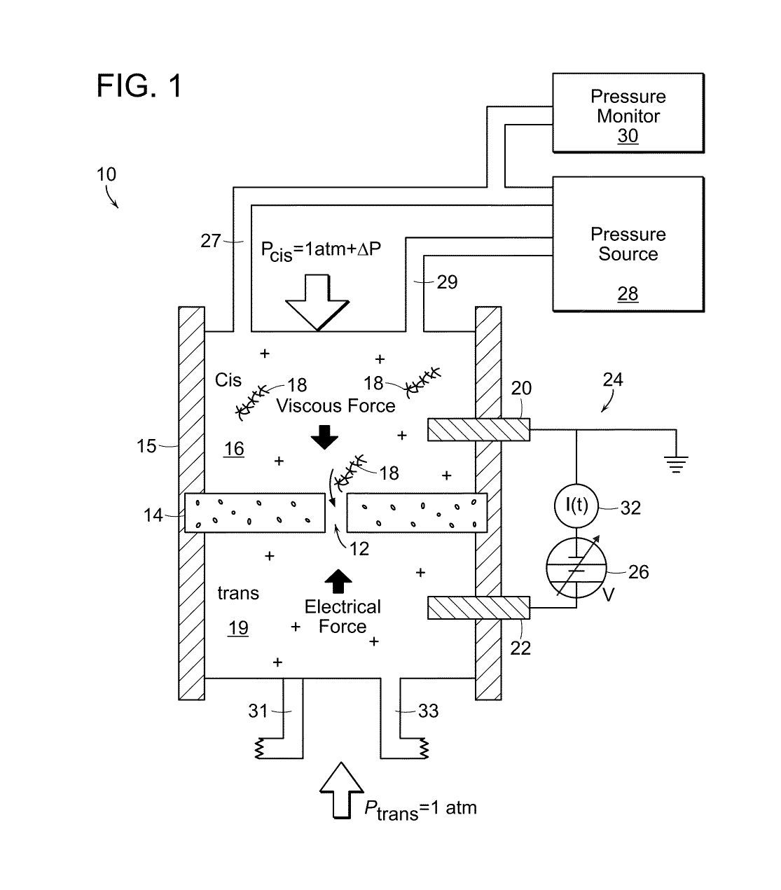

Referring to FIG. 1, there is shown a schematic perspective view of an example implementation of a pressure- and voltage-controlled nanopore system 10. For clarity of discussion, features illustrated in FIG. 1 are not shown to scale. As shown in FIG. 1, in the nanopore system there is provided a nano-scale aperture, or nanopore 12, in a nanopore support structure 14. The support structure 14 is configured in a fluidic cell 15 or other apparatus such that on a first, or cis, side of the nanopore is a connection to a cis liquid reservoir 16 or liquid supply containing a liquid solution including species 18 to be translocated through the nanopore, and on the second, or trans, side of the nanopore is a connection to a trans liquid reservoir 18, into which species are transported by translocation through the nanopore 12 from the cis reservoir. For many applications and examples herein, the cis liquid reservoir is here defined as that reservoir in which species are disposed for translocation through the nanopore. An electric field is applied across the nanopore, between the cis and trans reservoirs by the provision of, for example, a voltage bias that is set between electrodes 20, 22 in the cis and trans reservoirs. The electrodes are connected in an electrical circuit 24 that can include a controllable voltage source 26 for applying a selected voltage across the nanopore by way of the electrodes in solution.

Both or at least one of the reservoirs, e.g., the cis reservoir 16, is also connected to a pressure source 28, e.g., by way of input and output tubes 27, 29, for applying an external pressure to the reservoir. The pressure in the cis reservoir, P_{cis}, thereby is the combination of atmospheric pressure (1 atm) and any additionally applied external pressure, ΔP, or P_{cis}=1 atm+ΔP. A pressure monitor 30 can be connected to the cis reservoir to measure and monitor the pressure in the cis reservoir. The trans reservoir 18 is vented to atmosphere, e.g., by way of input and output tubes 31, 33. The pressure in the trans reservoir, Pₜᵣₐₙₛ, thereby is atmospheric pressure, or Pₜᵣₐₙₛ=1 atm.

The cis and trans reservoirs are configured to each hold a liquid solution, and the solution can include species to be translocated through the nanopore. In one example configuration, the liquid solution is an ionic solution, including electrically-charged ions, indicated as positive (+) in the figure for clarity. The support structure 14 in which the nanopore 12 is disposed can be provided as substantially impervious to liquid and to ion movement through the structure thickness, so that ionic flow and species movement between the two reservoirs is solely through the nanopore.

In operation, the pressure source 28 is controlled to impose an external pressure, ΔP, and a corresponding pressure-derived viscous force, at the cis reservoir 16 and species 18 in that reservoir 16. Concurrently, the voltage source 26 is controlled to apply a voltage bias across the nanopore by way of the electrodes 20, 22, in the cis and trans reservoirs. The imposed pressure and voltage bias can be controlled independently to control species movement. For example, the imposed pressure can be selected to produce a viscous force field that is sufficient to drive the species 18 through the nanopore from the cis reservoir to the trans reservoir. The voltage bias polarity can be selected to produce across the nanopore an electric field having a direction that opposes the direction of the pressure-induced viscous force field. Conversely, the voltage bias polarity and magnitude can be selected to produce an electric field that augments the viscous force field. Thus, the pressure and voltage bias can each be selected to achieve a desired control of species movement, such as slowing of species translocation through the nanopore, constraint of species in one of the two reservoirs at or near to the nanopore, or reversal of species translocation through the nanopore. The control parameters for each of these conditions are described in detail below.

With an applied pressure and applied voltage imposed on the nanopore system, the translocation of species between the cis and trans reservoirs can be detected, monitored, and analyzed to study the translocating species. In one detection technique, the flow of ionic current through the nanopore is measured. Here the external circuit 24 can include a suitable current monitor 32, such as a patch clamp amplifier, which can both monitor current as well as apply a bias voltage. As species translocation through the nanopore proceeds and the current monitor indicates translocation events, one or both of the external pressure and the external voltage bias can be adjusted to control the translocation, capture, and/or re-translocation of species at and through the nanopore. As explained in detail below, alternative species detection techniques can be employed, and no particular species detection technique is required.

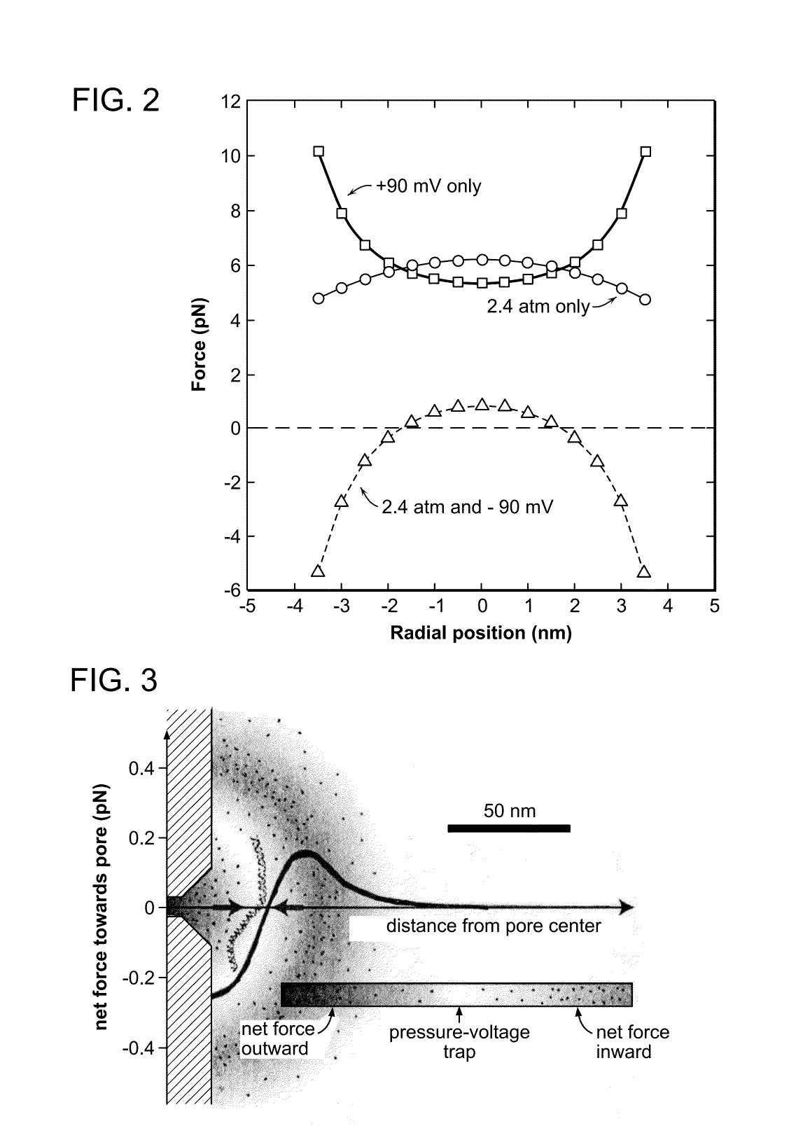

To demonstrate the interplay between the pressure-induced force and the electric field-induced force, FIG. 2 presents plots of computer-modeled voltage-induced electric field force and pressure-induced viscous force, modeled for a DNA molecule in the nanopore system of FIG. 1. Note the convention that positive applied voltage, V, and positive applied pressure, ΔP, both induce species translocation through a nanopore from the cis reservoir to the trans reservoir, while negative values retard such translocation. Thus, if positive ΔP and negative V are applied across a nanopore, the directions of the forces on a species in the cis reservoir are as shown in FIG. 1. In FIG. 2, the forces are taken as being parallel to the axis of the nanopore and are plotted as a function of radial distance from the nanopore center. The data correspond to a nanopore system including a nanopore of 10 nm diameter immersed in cis and trans reservoir solutions of 1.6 M KCl at pH 9. The modeling was achieved with the Poisson-Boltzmann-Navier-Stokes approach, as explained by Lu et al., in “Effective driving force applied on DNA inside a solid-state nanopore,” Physical Review E, V. 86, 011921-1-011921-8, 2012, the entirety of which is hereby incorporated by reference, and augmented by appropriate pressure boundary conditions far from the nanopore, as well as accounting for the viscosity of the fluid, the nanopore diameter, and the molecular diameter to determine the force profile. Included in the plotted data are the voltage-derived forces, including the viscous effects of electroosmotic flow, for +90 mV and −90 mV voltage bias, and pressure-derived viscous forces due to induced fluid flow, for an applied pressure of 2.4 atm and for a combination of the two forces. A positive-polarity voltage bias and positive polarity pressure bias cause DNA translocation through the nanopore from cis to trans reservoirs.

As shown in FIG. 2, the voltage-derived forces increase near the nanopore walls because the electroosmotic flow around the molecule, which reduces the net force, is suppressed by the no-slip, zero velocity boundary conditions at the nanopore walls. This demonstrates that even modest applied pressures, e.g., ΔP˜1 atm, can have a dramatic effect on control of species motion through a nanopore. The maximum of the parabolic pressure force is shown to be proportional to the square of nanopore radius, as expected from Poiseuille flow. By contrast, voltage-derived forces do not depend strongly on nanopore size; for a 10 nm-diameter nanopore, a change in nanopore size of 25% results in only a slight decrease (11%) of the voltage-derived force.

As explained above, by providing both electric field-induced force control and pressure-induced force control, the nanopore system can be regulated to control the translocation, capture, and/or re-translocation of species at and through the nanopore. In one nanopore control example, species translocation speed through a nanopore is controlled, e.g., to slow down translocation speed from that which would be attained by electrophoretic force alone. Such translocation speed control is particularly important for nucleic acid molecule nanopore translocation, which can in general be too fast for conventional electronic detection scenarios under typical voltage bias conditions. In this translocation speed method, the external pressure, ΔP, is introduced to the cis reservoir, which includes species to translocate the nanopore, and is controlled to produce a force field for driving the species through a nanopore from the cis to trans reservoirs. Concurrently, the voltage bias across the nanopore is controlled to produce an electric field that operates against the pressure field, i.e., that operates in the opposite direction, from trans reservoir to cis reservoir, but that is smaller than the applied pressure field, so that the force field due to applied pressure is larger than the electric field. With this arrangement, species traverse the nanopore because the pressure-derived force exceeds the opposing voltage-derived force, but the average speed of species translocation can be reduced by more than an order of magnitude from translocation speed under conventional voltage-driven electrophoresis.

In a further nanopore control example, the external pressure, ΔP, is introduced to the cis reservoir and an opposing electric field is imposed by a corresponding applied voltage bias, here with a polarity and magnitude that balances the electric field and the pressure field. It is herein discovered that when the net force at the nanopore is reduced nearly to zero, a physical trap for species in a reservoir can form just outside the boundary of the nanopore, in the reservoir, at an access region to the nanopore. While in this pressure-voltage trap, or ‘P-V trap,’ individual species, such as individual molecules, attempt to enter and translocate the nanopore multiple times before successfully translocating or diffusing away after a trapping duration. It is found that the trap conditions can be tuned to disallow translocation or diffusion during the trapping duration. Such tuning enables a direct measurement of the statistics of species capture and loss in a nanopore. In particular, the P-V trap enables the slowing of species translocation to the point where the fluctuating motion of a single molecule can be measured and studied.

To determine the conditions for P-V pressure balance, the net force on a species in the high-pressure, cis reservoir, under positive applied pressure, ΔP, and negative applied voltage, with the resulting force directionality as in FIG. 1, can be determined by modeling, e.g., by finite element calculations. FIG. 3 is a plot of such force modeling, showing the net force on one Kuhn length, or 100 nm, of double-stranded DNA (dsDNA) near a nanopore, with the dsDNA modeled as a cylindrical rod of diameter 2.2 nm. The distance is defined as the distance along the nanopore axis from the center of the nanopore to center of the rod. Positive forces are directed to the nanopore and negative forces are directed away from the nanopore.

In the plot of FIG. 3, the arrows show how the DNA molecule is physically focused and constrained at the location of zero force, near to the nanopore entrance, for an applied pressure of ΔP=2.2 atm and a voltage bias of V=−100 mV. Under these conditions, the net force on the molecule crosses zero at a location near to the nanopore, at an access region of the nanopore. At distances less than the zero crossing, the electric field is dominant, and the molecule's motion is directed away from the nanopore. At distances greater than the zero crossing, the viscous effect of the pressure-induced flow field is dominant, and the molecule is attracted to the nanopore. The net effect is that the molecule is focused towards the location of the zero force crossing point and trapped in the vicinity of the nanopore. The streaming potential is calculated to be 0.3 mV/atm and does not significantly affect the properties of the trap.

The existence of a force direction crossover near the nanopore can be understood as follows. Far from the nanopore, both the pressure-induced flow field and the electric field decay inversely with the square of the distance from the nanopore. Consider the case where the net force arising from the action of these fields on a molecule is zero, i.e., the forces are balanced. At the nanopore, the pressure-induced flow field is suppressed by the no-slip, zero velocity boundary conditions at the walls of the nanopore, leading to a parabolic radial force profile inside the nanopore. The electric field is not subject to these boundary conditions and therefore dominates at the nanopore. If the pressure is then increased slightly, the electric field still dominates inside the nanopore, but the pressure-induced flow field dominates at large distances from the nanopore, leading to a force direction crossover near the nanopore, within an access region of the nanopore. As a result, when the magnitudes of the pressure-induced flow field and the electric field are the same inside the nanopore, i.e., balanced inside the nanopore, the pressure-induced flow field still dominates in the reservoirs, outside the nanopore. Thus even when the two forces are balanced internal to the nanopore, the pressure-induced flow field can still impose a net force toward the nanopore. When the electric field is sufficiently strong, the zero-force location is in the cis reservoir, near to the nanopore.

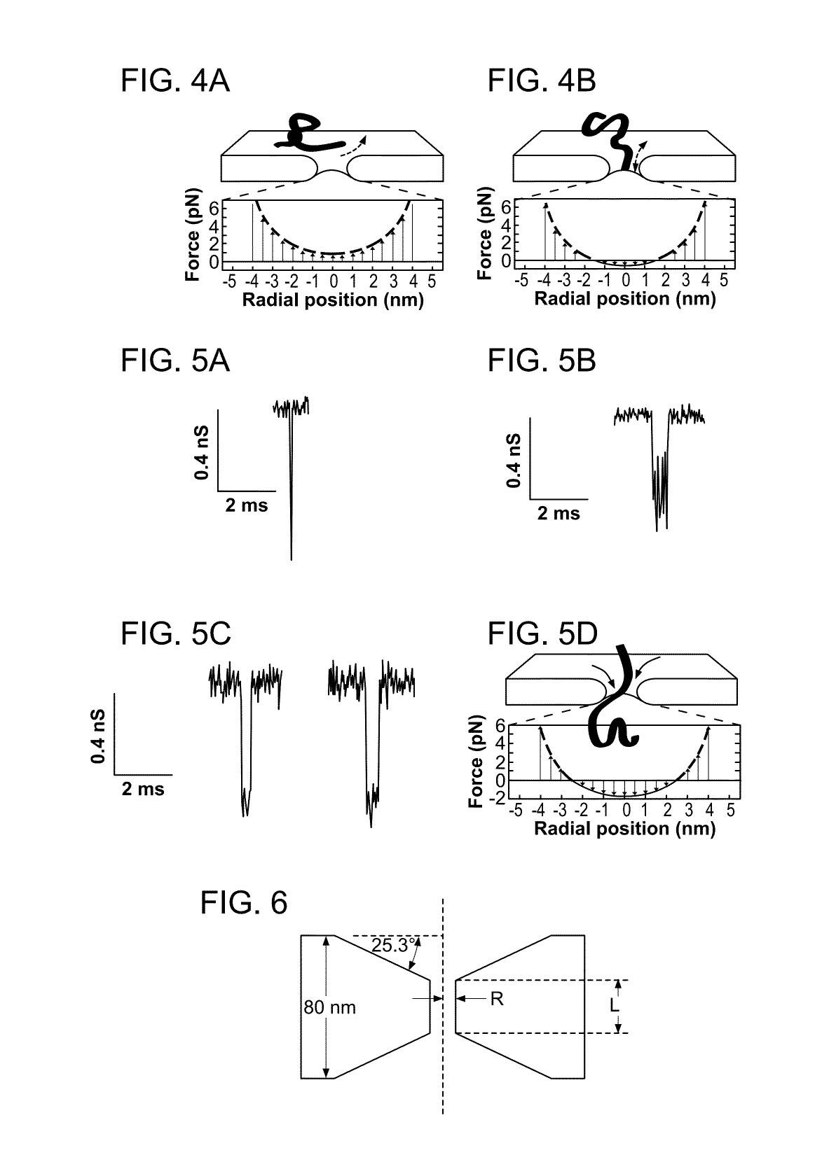

FIGS. 4A-4B provide schematic illustrations of a DNA molecule as the molecule approaches and then is confined in the P-V trap. FIG. 4A is plot of net force as a function of radial position from the center of a nanopore, modeled under the conditions of an electric field that is larger than a pressure-induced viscous field at the nanopore. Above the plot is schematically shown the corresponding motion of a DNA molecule in the cis reservoir. The molecule attempts to enter the nanopore, but there is no position across the nanopore radius for which entry or translocation is possible.

FIG. 4B includes a plot of net force as a function of radial position from the center of a nanopore, modeled here under the conditions of a force balance point at which the pressure-induced force and voltage-induced force are nearly balanced axially at the center of the nanopore. Above the plot is schematically shown the corresponding motion of a DNA molecule. For this condition, the pressure-induced force still dominates far from the nanopore, whereby the molecule is attracted to and then trapped at the access region of the nanopore even though the forces inside the nanopore do not allow translocation. The molecule may initiate nanopore translocation, but is repelled from the nanopore, and for some trapping duration, the molecule remains in the nanopore access region before either translocating through the nanopore or diffusing away from the nanopore. With this pressure balance control, a molecule can thereby be reliably trapped at a nanopore and the fluctuating motion of the molecule measured and studied. This capability enhances the utility of the nanopore system and enables understanding into single molecule dynamics in confined spaces.

Trapping of a species at the access region of a nanopore can be combined with nanopore translation speed control and even translocation directionality control, to fully control the motion of species near the nanopore. For example, the applied external pressure and voltage bias can be controlled in tandem to impose a sequence of nanopore control states. In one example sequence, the P-V trapping just described can first be imposed on a species in the cis reservoir, and then the pressure increased and/or the voltage bias reduced to cause species translocation from the cis to trans reservoirs at a selected translocation speed. Once in the trans reservoir, the species can again be trapped near to the nanopore, here in the trans reservoir, by adjustment of the applied voltage and applied pressure. Then the pressure can be reduced and the voltage bias increased to cause species translocation from the trans reservoir back to the cis reservoir. Thus, there can be achieved species capture, nanopore translocation, recapture, and reverse nanopore translocation by adjusting the direction of the net force on a species in the nanopore system with applied pressure and voltage bias.

This sequential species control can be further employed in a wide range of species analysis, such as electrical charge measurement. Such electrical charge measurement can be particularly important for measuring the charge of a single biological molecule such as a protein, RNA, DNA, or other biological molecule. In measurement of the charge of a species such as RNA, DNA or protein molecules disposed in the cis reservoir of the nanopore system as in FIG. 1, first there is determined the magnitude of externally applied pressure, ΔP, and applied voltage bias, V, that result in the P-V trap with zero net force described above. To initiate the empirical analysis, an applied pressure is imposed on the cis reservoir and a large counter electric field is imposed with an applied voltage bias that is of sufficiently high magnitude to substantially completely prevent approach of the species to the access region of the nanopore as well as translocation through the nanopore.

With this pressure and inhibitory voltage bias applied, movement of the species is detected to determine the net force on the species. In one detection example, the ionic current flow through the nanopore is measured with the nanopore circuit described above, as in FIG. 1, as the pressure and voltage are adjusted. With a large electric field opposing the applied pressure, no indication of species translocation through the nanopore is detected. Then, the magnitude of the applied voltage bias is reduced, in s suitable fashion, e.g., by incremental voltage reduction. As the voltage bias is reduced, the species can eventually reach the nanopore access region, and can attempt translocations, as shown in FIGS. 4A-4B. FIG. 5A is a plot of conductance at the nanopore as a function of time; the drops in conductance indicate attempts by the species to enter the nanopore before reaching the trap condition near to the nanopore, as in FIG. 4A. Continual reduction in the applied voltage bias enables achievement of the force balance condition as in FIG. 4B, at some reduced voltage bias, resulting in the species being trapped at a location of substantially zero net force. FIG. 5B is a plot of conductance at the nanopore for this condition, showing a deep, flat-bottomed ionic current flow drop corresponding to a translocation attempts within the physical trapping space at the nanopore.

The applied voltage bias magnitude is then reduced further until there is reached a voltage bias level at which successful nanopore entry and translocation by the species can occur. Here the pressure force is now greater than the opposing electrical field force. FIG. 5C is a plot of conductance at the nanopore for this condition, showing two ionic current flow blockage events due to nanopore translocation by the species. FIG. 5D provides a view of the physical species movement for these events, and plots the corresponding force as a function of radial position in the nanopore. Under these conditions, there exists a region of the nanopore at which the net force on the species is in the direction of nanopore translocation.

With the translocation event data from the voltage bias application and reduction, there can be determined the electrical charge on a species, based on a determination of the applied pressure and voltage bias for which the forces are balanced and a determination of the applied pressure and voltage bias for which translocation occurs. With this information, then using suitable modeling, the charge of the species can be calculated. Modeling can be implemented sufficiently with, e.g., a finite element system, such as the COMSOL 4.3 software from COMSOL, Inc., Burlington, Mass. As explained above, a Poisson-Boltzmann-Navier-Stokes formalism can be employed, whereby both the electrical and viscous forces on the species can be determined. The species can be modeled in any suitable manner. For example, a DNA molecule can be modeled as a rigid cylindrical rod having a selected length and radius and that is concentric with a nanopore of selected radius and length. To conduct the calculation, the applied pressure and voltage, the nanopore geometry, nanopore surface charge density, and dimensions and the charge state of the species are parameters of the model. Given sufficient constraints and knowledge of these parameters by independent methods, e.g. TEM, any of these model parameters can be determined.

Considering a specific example of determining the charge on a DNA molecule, with the measurements described just above there is known the open-nanopore conductance, the ionic current blockage level resulting from insertion of a DNA molecule into the nanopore, and the pressure and voltage required to balance the forces on the molecule in the nanopore. From these experimental observables, a self-consistent finite-element calculation can extract the geometric parameters of the nanopore and the DNA molecule, as well as the actual charge density of the DNA.

For these calculations, the geometry of the nanopore can be specified based on the nanopore formation. For example, for TEM-drilled nanopores, the geometry can be set as that which has been experimentally determined, e.g., by tomography, as described by Kim, M. J., McNally, B., Murata, K. & Meller, A., “Characteristics of solid-state nanometre pores fabricated using a transmission electron microscope,” Nanotechnology, V. 18, 205302 (2007), in which the nanopore is characterized as a cylindrical region separating two conical regions with an angle around 25.3° from the plane of the membrane, as shown in FIG. 6. The cone angle may not be precisely known for a given nanopore, but the results are not sensitive to this parameter below about 45°. The length and radius of the cylindrical region (hereafter “the nanopore”) is allowed to vary in the calculations, while the total membrane thickness and cone angle remain fixed.

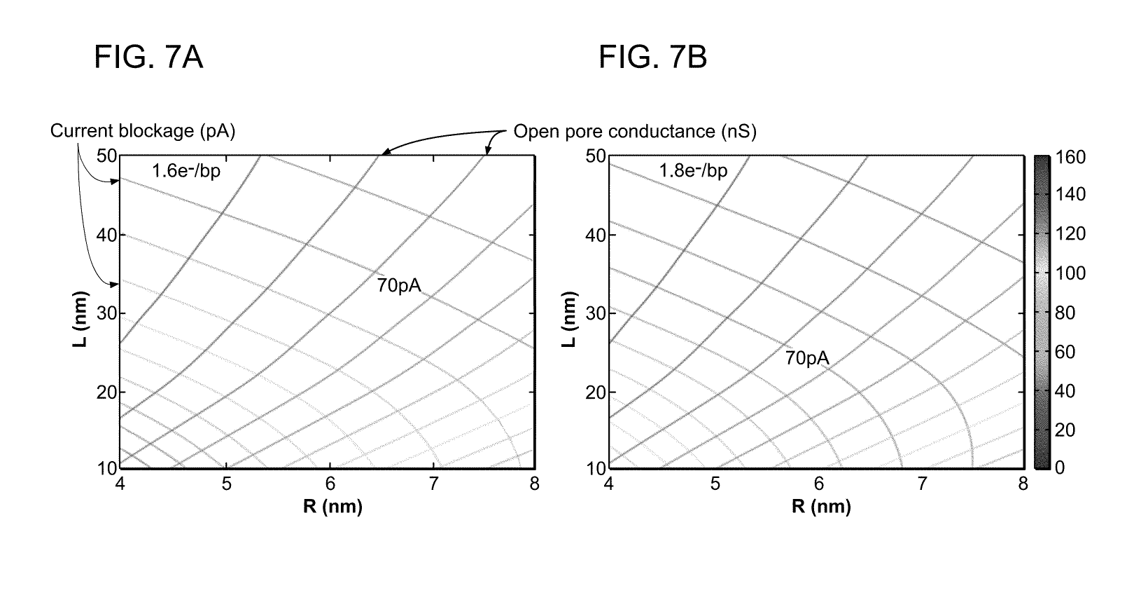

The open nanopore conductance and ionic current blockage from a DNA molecule in the nanopore can be calculated from the nanopore radius and length. Two such “conductance maps,” for two different values of the DNA charge density, are shown in the plots of FIGS. 7A-7B, demonstrating that the ionic current blockage of the nanopore is a strong function of the charge density on the molecule in the nanopore. Physically, this phenomenon arises because the presence of charge on a molecule, such as a DNA molecule, attracts counter-ions to the molecule from the electrolytic solution, increasing the conductance of the nanopore and leading to a decrease of the ionic current blockage through the nanopore.

This simple model has three free parameters: the two geometric parameters of nanopore radius and length, and the molecule charge density. There are also three experimental observables: the open nanopore conductance, the measured ionic current blockage, and the values of the applied pressure and voltage at the pressure-voltage balance point. In this formulation, therefore, the number of observables is equal to the number of free parameters, and the model is perfectly constrained by the experiment.

To solve the model for the nanopore radius, nanopore length, and molecule charge density, given the experimental observables, there can be employed, e.g., a modified Newton's method (iteration method). The first iteration in this method begins with an “initial value” i₁ of 2 e⁻/bp for the DNA charge density. By referencing the conductance map for this charge density (2 e⁻/bp), the nanopore radius, R, and length, L, are determined from the experimentally determined ionic current blockage and total ionic current. These values of the nanopore radius and length are used to calculate the pressure-derived forces F_{P}(R,L,i₁) and voltage-derived forces F_{V}, (R,L,i₁). Because experimentally these forces have been determined to be identical, for the force balance point, any difference in the calculation is interpreted as an error in the charge density. The charge density “result” r₁ is then given by r₁=i₁F_{P}(R,L,i₁)/F_{V}(R,L,i₁). The next iteration follows an identical procedure, in which the initial value of the charge density, iⱼ, is chosen between the initial value iⱼ₋₁ and result rⱼ₋₁ of the previous iteration. The result is calculated from rⱼ=iⱼF_{P}(R,L,iⱼ)/F_{V}(R,L,iⱼ).

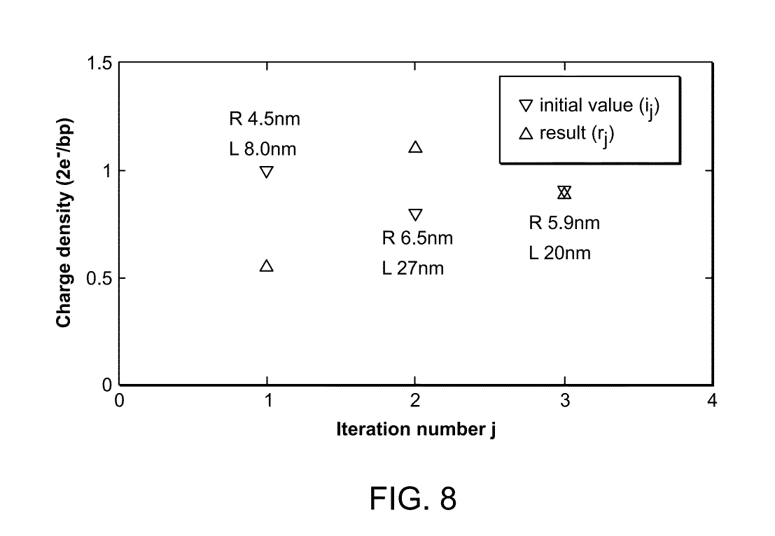

An example of experimental results produced using this iterative procedure is shown in the plot of FIG. 8. For the experimental conditions employed here, the open nanopore conductance was 57.3 nS, the ionic current blockage was 75 pA, and at the force balance point, the externally applied pressure was 2.51 atm and the applied voltage bias was −178 mV. With careful choice of the initial values, which were selected manually to minimize the number of iterations, only three iterations are required to achieve convergence within 2%.

It is discovered herein that determining the charge on a DNA molecule that is in an electrolytic solution, the above formulation describes the experimental data above pH 6 well. But as the pH drops below 6, it is found that in general, a larger applied voltage bias is required to counteract an applied external pressure, suggesting that the charge density on the DNA molecule is reduced at lower pH levels. It is understood that the properties of electrolytes near charged surfaces are well described by models in which a layer of immobilized material, consisting of water molecules and possibly counter-ions, are attached to the surface. The properties of this immobilized layer differ depending on the model invoked; the Stern model describes this layer as having uniform thickness and dielectric constant, with no free charges, as explained by Stern, O., “The theory of the electrolytic double shift,” Z Elktrochem Angew P, Vol. 30, pp. 508-516, 1924. The thickness of the layer is typically half the size of a hydrated ion, or 3-4 Å, as explained by Wang, H. & Pilon, L., “Accurate Simulations of Electric Double Layer Capacitance of Ultramicroelectrodes,” The Journal of Physical Chemistry C, Vol. 115, pp. 16711-16719, 2011. The dependence of the size of the Stern layer on surface charge is not known, as explained by Netz, R, “Electrofriction and dynamic stern layers at planar charged surfaces,” Physical Review Letters, Vol. 91, 138101, 2003, but it is expect to drop to zero for uncharged molecules. The effect of the Stern layer on the hydrodynamic properties of a surface has also not been extensively studied. Electrophoretic data have been understood by appealing to the additional thickness of the Stern layer, as explained by Schellman, J. A. and Stigter, D, “Electrical double layer, zeta potential, and electrophoretic charge of double-stranded DNA,” Biopolymers, Vol. 16, pp. 1415-1434, 1977, but it appears that there have been no prior direct observations of the hydrodynamic effects of the Stern layer size.

To incorporate the possible size effects of the Stern layer in the molecular charge calculation, a fourth parameter can be introduced into the model, namely, the DNA radius. While it appears that the model is now underdetermined, there are actually a number of additional constraints that can be imposed so that the model remains over-determined. Multiple pressure-voltage experiments at different pH values can be performed on the same nanopores, constraining the two geometric parameters for these nanopores. The DNA radius also can be constrained to be a constant above pH 6 and below pH 5, which are here termed the high and low charge density regions. Because the functional dependence of the effective DNA size with pH is not known, the nanopore geometries calculated at either high or low pH can be used to calculate the charge density in the transition region from about pH 5.5 to about pH 6.5. This approach is reasonable because the nanopore geometry does not change significantly as solutions of different pH are used in the same nanopore.

It is found, however, that the diameter of a solid state nanopore can change, e.g., become larger, in an electrolytic solution due to, e.g., etching of the nanopore by the electrolytic solution. For this reason, in the above model, the nanopore geometry is set as free parameters in the DNA charge calculation. It is known that a nanopore that is articulated in a solid state SiN support membrane can be slowly etched in an electrolytic solution such as 1.6M KCl pH 10; for these conditions, the nanopore diameter can grow at a rate of 0.5 nm per hour. If in the computation the nanopore diameter is instead set as a fixed, known parameter, then the calculation efficiency can be significantly improved.

This electrical charge measurement methodology can be applied to any suitable species, including, e.g., DNA molecules in different solutions of varying pH, or other biomolecules, solid state species, particles, and other species. The above example is provided only for description; there is no limitation on the species that can be analyzed for charge state. The charge measurement methodology can be implemented with species translocating through a biological nanopore, through a solid state nanopore, or through combination biological-solid state nanopore.

The charge measurement methodology is particularly well-suited for analyzing species such as proteins, other biomolecules for which the electrical charge is to be determined as a function of the solution in which the molecules are disposed. Of particular advantage is the ability here to detect the isoelectric point of a selected molecular species under selected conditions, e.g., selected pH, and for selected liquid environments. Also of particular advantage is the requirement for only a low concentration of species to be analyzed in making the charge determination. The charge can be determined here with only one or a few species molecules, in great contrast to many conventional techniques, such as isoelectric focus electrophoresis and mass spectrometry, which require large statistical populations. In addition, the P-V force balance methodology is not critically impacted by interaction between a species and a nanopore. Even molecules that stick to the nanopore or support structure provide useful data; detailed knowledge of where a molecule might be tethered to the nanopore or support structure is not required. The charge measurement methodology thereby enables very efficient and effective charge determination for any in a wide range of species.

In a further and related nanopore control example, the external pressure and voltage bias applied to a nanopore can be controlled to enable pressure-driven flow for the separation of species, e.g., the separation of mixtures of proteins. In one such example, a mixture of proteins is injected into the cis reservoir of a nanopore system and translocated through a nanopore with an applied pressure. A counter-voltage bias is then applied across the nanopore. Each protein has a unique hydrodynamic drag, which depends on that protein's conformation and size, and each protein has a unique electrical charge state, which depends on the experimental pH, the protein folding pattern, and the protein sequence. Thus for each protein there exists a unique counter-voltage bias that is required to exactly balance the hydrodynamic forces from the pressure-induced fluid flow. Provided these counter-voltage biases are sufficiently separated for the protein species to be separated, the counter-voltage bias can be tuned such that only one species can pass through the nanopore. Alternatively, by sweeping the applied voltage magnitude and observing the resulting ionic current through the nanopore, one can separate different species of proteins with different electrical charge states, so long as the charge is not so large as to cause response to very small voltages, or so small as to prohibit molecule speed control except with very large voltages. The pH of the electrolytic solution can be tuned to optimize the separation of a particular protein mixture for these conditions. This separation technique is complementary to so-called isoelectric focusing, in which proteins respond to a pH gradient rather than a sweep of voltage magnitude. Such a separation technique can be applied to any species, or class of species that can be translocated through a nanopore under pressure and applied voltage bias control.

Other separation techniques, e.g., separation by length, can be applied to separate species of different configurations, e.g., different molecular lengths, by measurement of their nanopore translocation duration. Because the nanopore translocation can be significantly slowed with the application of a counter force by an applied electric field, there can be obtained translocation duration data that enables resolution between molecules or other species, including biological species and molecules and solid state species, having differing lengths.

The charge measurement methodology and species separation methodology demonstrate the wide adaptability of the nanopore system with both pressure and voltage control. The external pressure can be employed as a force field to drive species through a nanopore while the voltage bias is applied as a counter force. As a result, the nanopore translocation speed can be slowed by an order of magnitude or more, providing the ability to improve the time resolution of species translocation, such as DNA molecule sequencing, on a large scale, while the SNR (signal to noise ratio) is maintained. Considering the particular species of DNA strands, the pressure and voltage control methodology eliminates limitations that can be imposed by uncontrollable interaction between DNA and a nanopore without requiring extremely small nanopore, e.g., less than 5 nm in diameter. This in turn eases the requirements to run a DNA sequencing experiment and improves the repeatability and controllability of the experiments. Furthermore, by suitably adjusting the cis and trans reservoir solution concentrations, and by adjusting the voltage bias and the external pressure, short DNA strands that are less than 3 kilo-base pair (kb) in length, 1 kb, or even 600 bp can be detected, an accomplishment that cannot be achieved by conventional nanopore sequencing techniques. This enables DNA detection with nanopores in a large scale, laying a solid foundation for achieving exact DNA sequencing.

The P-V trapping and translocation speed control described above enables trapping of a captured DNA molecule and the nanopore translocation duration to be extended by 4 to 5 orders of magnitude over conventional times, to as large as dozens of seconds, thereby enabling precisely single molecule capture and translocation. This in turn enables single molecule study in capture, detection and analysis, and DNA molecular dynamic study. For example, molecule structure, chemical reactive state and other bio-related information can be detected and analyzed.

These benefits are achieved with an elegantly simple arrangement of a nanopore system that can be easily assembled and has advantages of high controllability, repeatability and signal to noise ratio. All that is required is an extra pressure meter and a pressure source, such as HP gaseous nitrogen or gaseous oxygen, or other pressure source, such as a reaction cell, connected to a conventional nanopore system to introduce external pressure. No complex process or master skill is required, which is good for improving the success rate and efficiency of experiments. With DNA molecule translocation speed through a nanopore significantly slowed, the time resolution of detection is improved to a degree that cannot be reached by other methods while maintaining a high SNR; there is no need in the pressure-controlled nanopore system to reduce the voltage bias in an effort to slow down DNA molecule, and thereby a high SNR is maintained.

Turning to example implementations of the nanopore system of FIG. 1, a nanopore 12 can be provided in a support structure 14 in any suitable arrangement and material composition. The nanopore can be provided in a support structure that includes a solid state material, a naturally-occurring or biological material or entity, or some combination of solid state and biological materials. Microelectronic materials, such as silicon, silicon nitride, silicon oxide, aluminum oxide, hafnium oxide, and combinations of such, as well as other oxides and nitrides, are particularly well-suited to be employed in solid state nanopore embodiments. The support structure can be provided as a membrane of a layer or layers of materials or configurations that are self-supported across the membrane extent and that extend across a frame or other structure. Atomically thin materials, such as graphene, multi-layer graphene, boron nitride, and other atomically thin materials are also well-suited for solid state nanopore embodiments; here the graphene or other material can be provided as, e.g., a membrane supported at its edges by a frame. Examples of such materials to be employed in a solid state nanopore structure are described in U.S. Pat. No. 6,627,067, issued Sep. 30, 2003, and in U.S. Patent Appl. Publication No. 2012-0234679, published Sep. 20, 2012, the entirety of both of which are hereby incorporated by reference.

The nanopore can be provided in or as a biological material or entity, for example including a lipid bilayer or protein(s) in the construction of a channel operating as a nanopore. For example, a nanopore of alpha-hemolysin, MspA, or Aerolysin can be employed. A nanopore can also be formed by a combination of biological entities and solid state materials and/or support structures. Examples of such configurations to be employed in a nanopore structure are described in U.S. Pat. No. 6,746,594, issued Jun. 8, 2004, and in U.S. Patent Appl. Publication No. 2013-0146480, published Jun. 13, 2013, and in “Single Ion-Channel Recordings Using Glass Nanopore Membranes,” J. Am. Chem. Soc., V. 129 pp. 11766-11775, 2007, the entirety of each of which is hereby incorporated by reference.

The nanopore can be formed in any suitable shape, as an aperture, through-hole, channel, pore, or other opening that extends for connection between the two reservoirs. The nanopore can have any suitable geometry, both in cross-sectional shape and along the axial length of the nanopore, through the thickness of the support structure. For any nanopore geometry, it can be preferred that the nanopore cross-sectional diameter be on the nanometer scale; a diameter of less than 100 nm can be preferred, with a nanopore diameter of between about, e.g., 10 nm to 20 nm, or less than 10 nm; for some materials and applications, a nanopore of between about 1 nm-5 nm can be employed. The nanopore length is for many configurations the thickness of the structure or layers in which the nanopore is formed, and can be, e.g., nanoscale in length, such as 20 nm-100 nm, or less than 20 nm, e.g., between about 1 nm-20 nm.

The nanopore can have a constant diameter along nanopore length or can have varying geometry along nanopore length. For example, there can be employed a membrane or other structure in which is produced an aperture having a very sharp or pointed edge location at which the aperture diameter is reduced to the nanometer scale at some point along the length of an aperture through the membrane. Any nanopore configuration, whether solid state, biological, or some combination of such, in which a nanoscale aperture can be configured for providing a sole fluidic path between two reservoirs can be employed in the nanopore system.

To apply the voltage bias across the nanopore, there can be provided, as shown in FIG. 1, electrodes 20, 22, such as silver chloride electrodes, that are immersed in the liquid solutions on either side of the nanopore, for controlling the voltage of each solution. The solutions can be provided as any suitable liquid that does not prohibit nanopore translocation of a selected species. For many applications, an electrolytic solution can be preferred. The solution can be tailored for various considerations, e.g., for reducing the tendency of molecules, such as DNA molecules, to stick to the nanopore and surface structure, particularly graphene. For example, there can be provided an ionic solution that is characterized by a pH greater than about 8, e.g., between about 8.5 and 11 and that includes a relatively high salt concentration, e.g., greater than about 2M and in the range from 2.1M to 5M to prohibit molecular ‘stickiness’. But in general, any suitable selected salt can be employed, e.g., KCl, NaCl, LiCl, RbCl, MgCl₂, or any readily soluble salt whose interaction with the analyte species is not destructive.

There is no limitation on species that can be accommodated in the nanopore pressure and voltage control system; any species that can translocate through a selected nanopore can be employed, and species that can be delivered to the nanopore in an electrolytic solution are particularly well-suited for the nanopore system. As explained above, in such an electrolytic solution, there can be detected and measured the flow of ionic current through the nanopore for detecting species motion at the nanopore. The species can be solid state, biological, naturally-occurring, synthesized, and of any composition and combination that is suitable for a given nanopore system. The species can be molecules, molecular fragments, molecular strands, and components of larger entities. As explained above, biomolecules, polymer molecules, DNA, RNA, PNA, proteins, oligonucleotides, nucleotides, and other biological molecules and polymer molecules all can be particularly well-characterized by the nanopore system. Solid state particles, such as nanoparticles, of varying electrical charge and uncharged, as well as solid state structures, components, and any in a wide range of materials can be provided as a species for analysis in the pressure-controlled nanopore system.

To configure the nanopore and reservoirs of analyte species in the nanopore system of FIG. 1, the mounted support structure, e.g., membrane, can be inserted between two half-cells in a flow cell arrangement, such as a microfluidic cassette of polyether-etherketone (PEEK) or other suitable material. The liquid configuration can be sealed with gaskets, e.g., polydimethylsiloxane (PDMS) gaskets. It can be preferred that the gasket orifice be smaller than the dimensions of the support structure to completely seal off the edges of the support from the solutions.

As shown in FIG. 1, the nanopore system can be connected to an external circuit 24 to enable monitoring of ionic current flow through the nanopore. This ionic current monitoring technique is a well-established method for determining the existence and position of a species in an ionic solution relative to a nanopore. The nanopore pressure and voltage control techniques do not require ionic current flow measurement for species detection, and indeed, any suitable species detection technique can be employed. For example, there can be measured the tunneling current between two electrodes, such as carbon nanotubes, that are disposed or articulated at the nanopore for analyzing species at the nanopore. Alternatively, conductance changes in probes at the nanopore or conductance changes in the nanopore support structure itself can be monitored for species detection. In a further class of detection techniques, a localized electrical potential measurement can be made to analyze species at the nanopore. Such alternative detection methods can be employed as described in U.S. Pat. No. 7,468,271, issued Dec. 23, 2008, and U.S. Patent Application Publication No. 2014-0190833, published Jul. 10, 2014, the entirety of both of which are hereby incorporated by reference. In general, any detection technique that enables discernment of species trapping and translocation can be readily employed.

With the nanopore system configured and a selected detection arrangement in place, the nanopore system can be operated. In practice, the strength of the nanopore support structure dictates the maximum pressure that can be applied to one of the fluidic reservoirs. For example, given a silicon nitride membrane as a nanopore support structure, then a pressure of no more than about 40 atm should be applied to a reservoir to preserve the integrity of the silicon nitride membrane. For many nanopore system experiments, an applied external pressure of between about 0 atm and about 5 atm can be sufficient to enable species translocation and trapping.

Similarly, the strength of the nanopore support structure dictates the maximum electric field that can be applied across the nanopore. For example, given a silicon nitride membrane of about 100 nm in thickness as a nanopore support structure, then the maximum voltage that can be sustained across the silicon nitride membrane is about 10 V. For many nanopore experiments, an applied voltage bias magnitude of between about 40 mV and about 500 mV can be sufficient for many species analyses. It is recognized that for some species detection methods such as ionic current flow measurement, the applied voltage also is required to enable the detection circuit. A voltage above about 40 mV can here be preferred. But it is recognized that the applied circuit voltage can be substituted by a lock-in amplifier, thereby removing a requirement for a minimum voltage.

For many implementations and applications, it can be preferred, once the nanopore system is configured and ready for operation, to ‘start up’ the nanopore system in a manner that prevents clogging of the nanopore prior to nanopore translocation detection. In one method for preventing such, the nanopore system operation is commenced with the application of a substantial counter voltage bias, e.g., a bias voltage of between about −100 mV and about −500 mV. This large counter bias prevents the accumulation of species from the cis reservoir at the nanopore. With this voltage bias in place, then an external pressure of, e.g., between about 1.0 atm and about 3 atm can be imposed to initiate movement of species in the cis reservoir toward the nanopore. A nanopore translocation detection method is initiated at that time to record species movement relative to the nanopore.

Turning now to an example of nanopore system construction and operation, the description below is provided to give those of ordinary skill in the art a complete disclosure and description of how to make and use example embodiments, and are not intended to limit the scope of what the inventors regard as their invention. Unless otherwise specified, all experimental methods are conventional, and all experimental reagents and materials can be found commercially.

Chip device fabrication: The purpose of this procedure is to fabricate solid-state nanopore devices that can be operated in a transmission electron microscope (TEM). This process involves two separate steps. The first is to make freestanding SiN membrane structures that can fit on a TEM sample holder. The second is to drill a nanopore through the freestanding SiN membrane with a converged electron beam. The details of an example experimental procedure: a 150-200 nm-thick silicon nitride layer was grown by low pressure chemical vapor deposition on a 380 μm-thick silicon substrate including a 2 μm-thick silicon dioxide layer. Using electron beam lithography and reactive ion etching (RIE), square windows of about 584 μm on edge in the silicon nitride mask layer at one side were obtained. Arrays of 3×3 mm chips were thereby defined, each with a 584 μm square in the middle. For the convenience of slicing later, small features with width 5 μm, length 20 μm were added. The mask parameters for photolithography were as follows: mask size: 5 inch; patterns: 100 mm in diameter; crystal direction indicator: 50 mm length, 0.8 mm width, 49 mm to the middle of the substrate.

Referring to FIGS. 6A-6F, using photolithography as shown in FIG. 6A and reactive ion etching (RIE) as shown in FIG. 6B, the silicon dioxide layer and the SiN layer were etched down to the silicon wafer, as shown in FIG. 6C. Subsequently, pyramid-shaped holes were etched in the silicon wafer by KOH wet etching (40% KOH, 80° C., 6 hour) as shown in FIG. 6D. The SiN layer in the holes should be flat, and around 20-80 μm, as shown in FIG. 6D. The wafer was then sliced into 3×3 mm chips with protection of blue plastic. To conduct this step, stick the wafer for slicing to another protection silicon substrate with wax at high temperature. Then stick blue plastic to the backside of the protection substrate. After slicing in 200-250 μm depth, remove the blue plastic, protection substrate and wax. Each SiN/Si+ wafer (4 inches in diameter) was processed to produce more than eight hundred 3×3 mm² square chips. Phosphoric acid was used to etch SiN membrane to 70 nm thick at 1-5 nm/min at 160° C. To reduce the capacitance noise in making nanopore measurements, and to increase the probability of nanopore wetting in the fluidic solution, the membrane thickness was reduced, as shown in FIG. 6E. A focused ion beam microscope (FIB, DB 235, FEI) was used to the etch silicon dioxide to 0.5 μm in thickness in a 1×1 μm area. Then an RCA reaction was used to remove the remaining 0.5 μm-thick silicon dioxide layer, shown in FIG. 2F. In this step, the RCA reaction included: NH₃:H₂O:H₂O₂=1:1:5(v/v), 10 min at 70° C.; BOE (HF:NH₄F:H₂O=1:2:3) 6 min with etch rate 100 nm/min; and HCl:H₂O₂:H₂O=1:1:5(v/v/v), 10 min at 70° C. to remove inorganic contamination.

Nanopore Drilling in a TEM: This step is to fabricate a nanopore in an as-prepared freestanding SiN membrane support structure. A transmission electron microscope (FEI Tecnai F30) was used to a drill nanopore under the following experimental conditions: magnification 520 k-890 k, spot size: 1. A nanopore with 10 nm diameter and 60 nm thickness is achieved within 5 min in this way. The sample holder was cleaned in a plasma cleaner (O₂:Ar=1:3,v/v) for 1 min both before and after nanopore drilling. The nanopore device was stored in dry vacuum container drilling.

Ionic current signal measurement under pressure force: This step is to detect an ionic current signal through the nanopore under a driving pressure force. The nanopore device was sealed with PDMS gaskets and PEEK fluidic cells, with the nanopore being the only channel connecting cis and trans chambers. Two electrodes (Ag/AgCl) were inserted in the two fluidic reservoirs separately. The electrolytic solution included 1.6 M KCl, 1 mM EDTA and 10 mM Tris (pH=8). 3 kb DNA molecules were injected to the cis chamber. Pressure was introduced between cis and trans chambers by connecting the cis chamber to a compressed nitrogen container. A valve control ‘T’ connector was used to combine the pressure proof tubes from the compressed nitrogen container to the flow cell chamber. One of three outlets of the ‘T’ connector was used for venting. A pressure monitor for detecting pressure value in the cis chamber was employed.

By adjusting the pressure from the pressure source, e.g., the compressed nitrogen container, a pressure force field between the two fluidic chambers was introduced to the system. Then the ion current signal was measured at an opposing applied voltage of −100 mV with the patch clamp system. Since DNA is negatively charged in solution, the negative polarity applied bias reduced the DNA translocation speed through nanopore. By adjusting the pressure and voltage, the DNA molecule inside the nanopore can be manipulated controllably, for example, to reduce translocation speed and stay inside the nanopore for an extended duration while maintaining the excellent signal/noise ratio and high capture rate. Here two parameters were used to characterize single DNA molecule translocation events: current blockage and translocation time. Experimentally, 3 kb DNA events were successfully detected under the experimental conditions of: pressure 2.4 atm; opposing applied voltage bias 100 mV, with average translocation time 800 μs and current 70 pA. Conversely, DNA events driven only by electric force were found to have an average translocation time of 100 μs, demonstrating that the pressure-controlled translocation was almost one order of magnitude slower than normal electric force-driven DNA translocation.

Reduced translocation speed of DNA molecules with different lengths: This step shows the effect of pressure control on nanopore translocation of molecules, such as DNA molecules, of different lengths. Here 600 bp DNA molecules were detected under the experimental conditions of: pressure 2.4 atm; opposing applied voltage bias 100 mV, with average translocation time of 100 μs. Normally it is hard to detect 600 bp DNA using conventional equipment, due to the short length of 600 bp DNA and the relatively low time-resolution of equipment. This clearly shows the advantage of the pressure-controlled nanopore, in successfully detecting shorter DNA molecules, which is quite difficult for other nanopore techniques.

Single molecule capture for ultra-long time duration: This step shows how to capture a single molecule in a nanopore for ultra-long time with the pressure control. The DNA molecule can remain in a nanopore for very long time if the external force is balanced by adjusting the opposing applied voltage bias and the applied pressure, which can be used for single molecule capture and to control DNA translocation speed. Here 3 kb DNA translocation events with more than ten seconds translocation time were obtained at pressure 2 atm and an opposing applied voltage of 100 mV. In addition, there was achieved the capture and recapture of DNA molecules by adjusting the applied pressure and voltage. When introducing 2 atm pressure, DNA molecules were prone to stay in the nanopore because the external force on the DNA molecule was almost balanced compared to the condition at 2.4 atm pressure. When the external force was changed, for example, by a pressure decrease to 1.8 atm, the DNA was forced into the cis chamber. The same situation would happen if the opposing applied voltage bias was increased to 105 mV. By adjusting applied the pressure and electric force, DNA molecules can be manipulated controllably inside nanopore.

It is to be recognized that these examples demonstrate abilities of the nanopore system under particular implementation conditions, but such are not required. For example, the nanopore system can be configured to enable external pressure application to both the cis and trans fluidic reservoirs, so that the directionality of the pressure application can be reversed in the manner that the voltage bias polarity can be reversed. All that is required is the application of external pressure to at least one fluidic reservoir. For many implementations, the external pressure is to be applied to that reservoir which contains species for translocation through the nanopore, with that fluidic reservoir being termed the cis reservoir. For some applications, external pressure application without voltage bias application can be employed for species analysis and translocation. In examples above there was described the concurrent application of external pressure and an external voltage bias, but such is not in general required—for some applications, an external pressure can be applied alone. In some implementations, the external pressure application and external voltage bias can be controlled separately, and can be simultaneous or alternating, with periodic or aperiodic temporal control.

### Example I

This example describes an experimental comparison between a nanopore system employing a conventional voltage bias-based electrophoretic nanopore translocation force and a nanopore system including pressure-based nanopore translocation force and opposing voltage bias force.

Nanopores were formed in silicon nitride membranes in the following manner. Thin films of 2 μm-thick wet thermal silicon oxide and 100 nm-thick LPCVD low-stress (silicon-rich) silicon nitride were deposited on 500 μm-thick thick P-doped <100> Si wafers of 1-20 ohm-cm resistivity. Freestanding 20 μm-thick membranes were formed by anisotropic KOH (33%, 80° C.) etching of wafers in which the thin films had been removed in a photolithographically patterned region by reactive ion etching. A focused ion beam (Micrion 9500) was used to remove about 1.5 μm of silicon oxide in a 1 μm square area in the center of the freestanding membrane. A subsequent timed buffered oxide etch (BOE) removed about 600 nm of the remaining oxide, leaving a 2 μm-thick free-standing “mini-membrane” of silicon nitride in the center of the freestanding oxide/nitride membrane. The nitride film was about 80 nm-thick after processing in KOH and BOE, as measured by ellipsometry and cross-sectional transmission electron microscopy (TEM). A focused 200-keV electron beam from a JEOL 2010F field-emission TEM (JEOL USA, Peabody, Mass.) was used to form roughly hourglass-shaped nanopores in the center of the nitride mini-membrane. The nanopore diameters were approximately 10 nm.

A nanopore was configured in a nanopore system for translocation of DNA there through. 3270 bp (3.27 kbp) circular plasmid vector pENTR/D-TOPO was prepared from E. coli using a CWBI^{O}® PurePlasmid Mini Kit (Beijing CoWin Bioscience Co., Ltd., Beijing, China) and linearized by digestion with EcoRV restriction endonuclease. DNA fragments of 615 bp and 1140 bp (1.14 kbp) were produced from an Arabidopsis thaliana cDNA library by polymerase chain reaction. All lengths were purified using Invitrogen® Purelin^{k}™ Quick Gel Extraction and PCR Purification Combo Kit (Life Technologies Corp., Grand Island, N.Y.) following gel electrophoresis.

A nanopore-articulated membrane was mounted in a sealed cell such that the freestanding membrane containing the nanopore separated two electrically isolated reservoirs of 1.6 M KCl maintained at pH 9 by 10 mM Tris and 1 mM EDTA buffer, unless otherwise specified. The cell was capable of withstanding several atmospheres of internal pressure. Using estimates of the Young's modulus and yield strength of silicon nitride as 300 GPa and 0.6 GPa, respectively, it was estimated that the thin membranes are capable of withstanding over 40 atm of pressure without mechanical failure. As discussed above, however, the pressure required to offset a given voltage is proportional to the square of a nanopore radius. Because an exceptionally robust flow cell is required to apply the high pressures required for smaller nanopores, for this experiment, there was employed the relatively large, 10 nm-wide nanopores and modest pressures. Pressure was applied to one of the sides of the nanopore using a regulated tank of compressed nitrogen or regulated compressed air; the pressure was read using a pressure meter with a nominal precision of 0.5% (about 0.01 atm). The opposite side of the membrane was maintained at atmospheric pressure.

DNA was diluted to about 2 ng/μL in the buffer solution at pH 9 by 10 mM tris buffer and introduced into the nanopore fluidic cell system, which was then sealed so that external pressure could be applied. All electrical measurements were carried out inside a dark Faraday cage with external circuitry coupled to the electrolyte reservoirs with Ag/AgCl electrodes. An Axopatch 200B patch-clamp amplifier (Molecular Devices, Sunnyvale, Calif.), operating in resistive feedback mode with an 8-pole, 40-kHz, low pass Bessel filter was used for measuring ionic currents and for applying voltage biases across the nanopore. All rms noise levels refer to an integration of the current noise power spectrum between 200 Hz and 40 kHz. All voltages are referenced to the high-pressure side of the nanopore, where the molecules are provided for translocation; negatively-charged molecules such as DNA, negative voltages retard translocation, while positive voltages facilitate translocation. The amplifier output was digitized at 250 kHz to reduce aliasing and was continuously recorded to disk using a Digidata 1440A digitizer and pClamp 10 software. The digitized ionic current signals were processed using custom MATLAB code (The MathWorks, Natick, Mass.) that fit each event to a series of sharp current steps modified by the transfer function of the experimental low-pass filter.

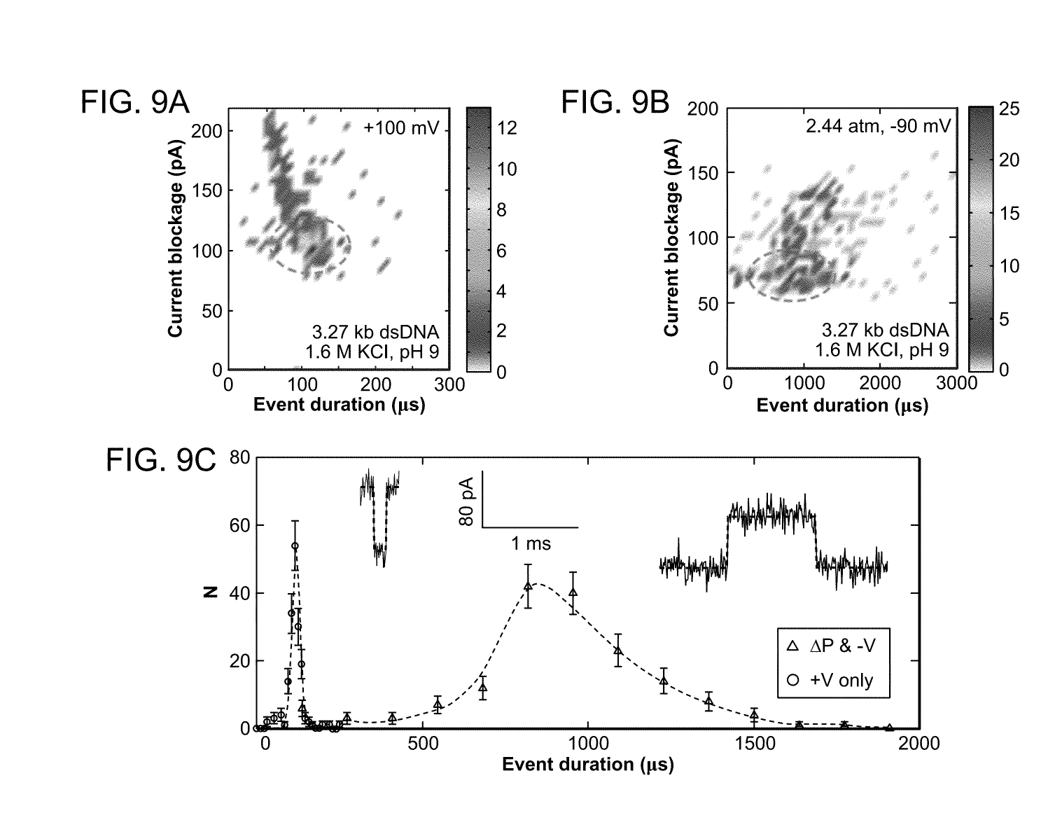

An external voltage bias of V=+100 mV was applied across the nanopore, with a zero applied differential pressure, ΔP=0 applied across the nanopore. FIG. 9A is a density histogram of the resulting measured ionic current blockage through the nanopore versus translocation event durations for the 3.27 kbp double-stranded DNA (dsDNA). The conductance was 67 nS in the 1.6 M KCl electrolyte and the rms noise level was 10.9 pA. The noise level was deduced from current noise power spectra integrated from 200 Hz and 40 kHz. Molecules were captured at an average rate of 50 per minute.

To compare this electrophoretic translocation control with pressure-driven translocation control, there was then applied an external pressure ΔP=2.40 atm at an applied voltage of V=−90 mV across a nanopore of 43 nS conductance.

FIG. 9B is a density histogram of the resulting measured ionic current blockage through the nanopore versus translocation event durations for the 3.27 kbp double-stranded DNA (dsDNA). The rms noise level at V=−90 mV was 10.7 pA. This demonstrates that with external pressure driving the translocation and voltage bias opposing the translocation, the molecules pass through the nanopore only because the pressure-derived force exceeds the opposing voltage-derived force. The average speed of the DNA through the nanopore for these conditions is an order of magnitude lower than for the voltage-driven translocation results reported in FIG. 9A, while the capture rate of 10 events per minute is about a factor of 5 lower. This factor of 2 for the ratio of the reduction in the capture rate to the reduction in average speed is typical for these experiments. The mean translocation time for unfolded events, selected as previously described, increased from 115 to 950 μs, as shown in the distributions plotted in FIG. 9C, which shows the unfolded event duration histograms from the plots of FIGS. 9A-9B. The dashed lines represent the fits from which the event durations are determined. The two insets are typical current blockage events from the experiments. Further attempts to balance the pressure- and voltage-derived forces resulted in additional slowing, up to a factor of about 20.

One notable difference between the density histograms shown in FIG. 9A and FIG. 9B is the behavior of “folded events,” which have higher average current blockage than unfolded events. In the data shown in FIG. 9A for the voltage-only translocation experiment, the molecules that are captured from a fold at their center go through the nanopore in approximately half the time of the unfolded molecules. This occurs because the force in the nanopore is positive over the entire cross-section of the pore, and the average force on the two strands is approximately double that of a single strand. The drag of two strands is also double that of one, but the length is half as long, so the translocation time is about half that of the unfolded molecules. Data in FIG. 9B, on the other hand, shows that in a nanopore biased with both pressure and voltage, the translocation times of folded molecules are as long as or longer than those of unfolded molecules. This occurs because the direction of the net force reverses if the molecule departs significantly from the axis of the nanopore. When two DNA strands are in the nanopore, they repel each other such that one or both are always likely to be displaced from the nanopore axis. In the case where the pressure- and voltage-derived forces are well balanced, the net force on the two strands may thus be less than that on a single strand. This slows translocation of folded molecules, resulting in the observed increased translocation times for folded molecules.

### Example II

This example demonstrates experimental processing of dsDNA molecules with a nanopore from Example 1, controlled by both external pressure and voltage, to resolve a mixture of dsDNA molecules of different lengths.

One of the advantages of slowing nanopore translocation with pressure in the presence of a high opposing electric field is the ability to detect and resolve the lengths of very short molecules. Conventionally, when controlling nanopore translocation with only a voltage bias, the difficulty of resolving short molecule lengths comes from the poor signal to noise connected with the high bandwidth needed to resolve short blockage signals.

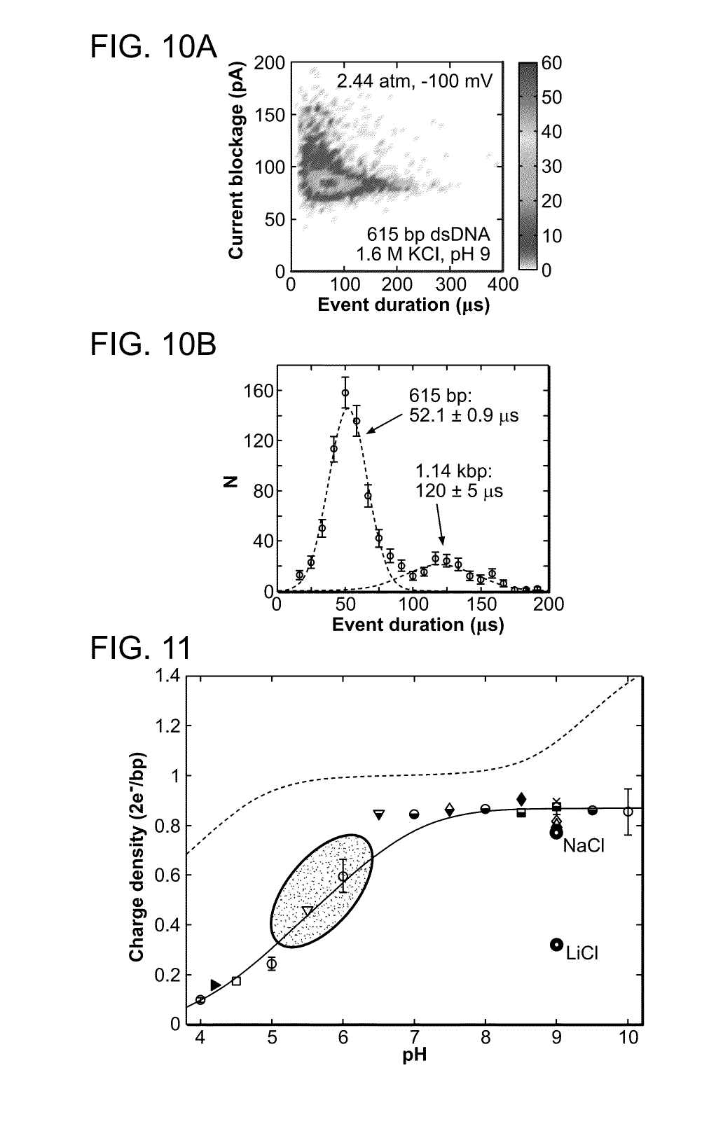

A nanopore fabricated as in Example I was configured with a cis reservoir including 615 bp dsDNA molecules. Translocation through the nanopore was controlled with an external pressure ΔP=2.44 atm and a voltage bias V=−100 mV. The nanopore conductance was 60 nS and the rms noise level was 11.9 pA at V=−100 mV. In FIG. 10A there is plotted a density histogram that was produced for measured nanopore translocations of the 615 bp dsDNA molecules.

A second nanopore fabricated as in Example I was configured with a cis reservoir including 615 bp dsDNA molecules and 1.14 kbp dsDNA molecules. The applied external pressure was ΔP=2.56 atm and the voltage bias was V=−100 mV. The nanopore conductance was 43 nS, and the rms noise level was 15.8 pA.

FIG. 10B is a plot showing length discrimination between the two different length molecules. The standard deviations of the weighted Gaussian fits are 14.2±0.8 and 26±4 μs. The peak separation of about 70 μs is significantly greater than the peak widths (about 40 μs), all determined from weighted least-squares fits of two Gaussians (χ²=1.07). This demonstrates that molecules of different lengths can be resolved clearly by use of pressure and voltage control of nanopore translocation and by analysis of the resulting nanopore translocation durations.

### Example III

This example describes an experimental determination of the electrical charge of DNA molecules in different electrolytic solutions having a pH ranging between pH 4 and pH 10 in a 1.6 M KCl solution.

Eight different nanopores having a diameter of between about 8 nm and about 10 nm were fabricated as in Example I. Each was separately configured with a flow cell having a cis reservoir including an electrolytic solution of 1.6M KCl, with 10 mM Tris and 1 mM EDTA with dsDNA.

The experiments described above for obtaining a pressure-voltage force balance were conducted. In this process, an initial external pressure of about 1˜2 atm was applied. A very large counter applied voltage bias of about −600 mV was initially applied to prevent pressure-driven DNA molecule translocation. Then the voltage bias magnitude was slowly reduced. For each of the experiments, the pressure-voltage force balance point was typically at a counter voltage drop of between 300˜100 mV for the applied pressure. Under constant pressure, if the counter voltage at balance point is high, it indicates the charge of molecule is low.

The iterative computation described above for determining charge on a species was conducted for the experimental nanopores. The results of these calculations are plotted in FIG. 11 to present the measured DNA charge as a function of electrolyte pH. In the plot, open symbols indicate data from free nanopore translocation, while filled symbols indicate tethering results, i.e., molecular movement that occurred while a DNA molecule was found to become tethered, or stuck, to the nanopore or support structure. Half-filled symbols include both types of data. For clarity, error bars of 11% are shown only for representative points. The transition region from a state of high charge density to a declining charge density is shaded. The solid line represents a fit to a single acid equilibrium constant (pKa=4.74±0.07), including the activity of the hydrogen ions near the charged molecule surface. The dashed line is a calculation from the acid-base equilibria of individual nucleotides. The discrepancy between the experimental measurement and the theoretical curves indicate that DNA absorbed cations from the solution. It is discovered that the absorption rate can be very different for different electrolytes, such as NaCl or LiCl, as shown labeled with black circles in the plot.

The data are well described by a low pH value with a DNA radius of 0.9 nm and a high pH value with a DNA radius of 1.25 nm. It is observed that at pH values greater than 7, the charge density is a constant 0.87 times 2 e⁻/bp. The charge density decreases under acidic conditions to a very small value at pH 4.

Error bars are estimates based on the uncertainties in experimental parameters. Because the pressure-voltage force balance point was determined from discrete voltage levels spaced about 10% apart, the balance point carries about 10% uncertainty. Through the self-consistent calculations, this uncertainty translates into about a 5% uncertainty in the charge density. Also, by assuming that all the samples should have approximately the same nanopore length, and inspecting the distribution of calculated nanopore lengths, the influence of the uncertainty in the nanopore length on the charge density can also be determined to be about 10%. The net error is then estimated to be approximately 11%, which is plotted as the error bars in FIG. 11. By comparison, the charge density determinations at pH 9 have a standard deviation of only 7%.

This example demonstrates that the electrical charge of a molecule can be determined with a nanopore, and that the nanopore system enables charge determination for a range of conditions, such as differing liquid pH, electrolyte composition, or solvent

### Example IV

This example describes experimental formation of a pressure-voltage trap at a nanopore, measurements of molecular motion relative to the trap, and modeling of the measurements.

A 10 nm-diameter nanopore fabricated as in Example 1 was configured in a flow cell with 615 bp dsDNA in the cis reservoir. As in the examples above, the DNA was provided in an electrolytic solution of 1.6 M KCl buffered at pH 8 by 10 mM Tris buffer and stabilized against multivalent ions by 1 mM EDTA. The DNA concentration in solution was 2 ng/μL. The nanopore conductance was 59 nS.

An external pressure, ΔP, was applied to the cis reservoir at eleven different pressure values between 1.64 atm and 2.44 atm. For each pressure, the voltage bias was maintained at V=−100 mV. The rms noise level, calculated by integrating the current noise power spectral density from 200 Hz to 40 kHz, was 12 pA at V=−100 mV. For each applied pressure, the ionic current through the nanopore was monitored with the Axopatch 200B current amplifier. Electrical signals were hardware filtered with a 40 kHz 8-pole low-pass Bessel filter before digitization at 259 kHz.

In a second experiment, there were also acquired ionic current measurements, here for 3.27 kbp dsDNA molecules in the same cis ionic solution. The nanopore conductance here was 126 nS. An external pressure ΔP=0.865 atm was applied with a voltage bias V=−100 mV. The pressure was reduced in this experiment because the diameter of the second nanopore was larger, 14 nm. Pressure-derived force is proportional to the cross-sectional area of the nanopore. The rms noise level in this experiment was 13.1 pA.

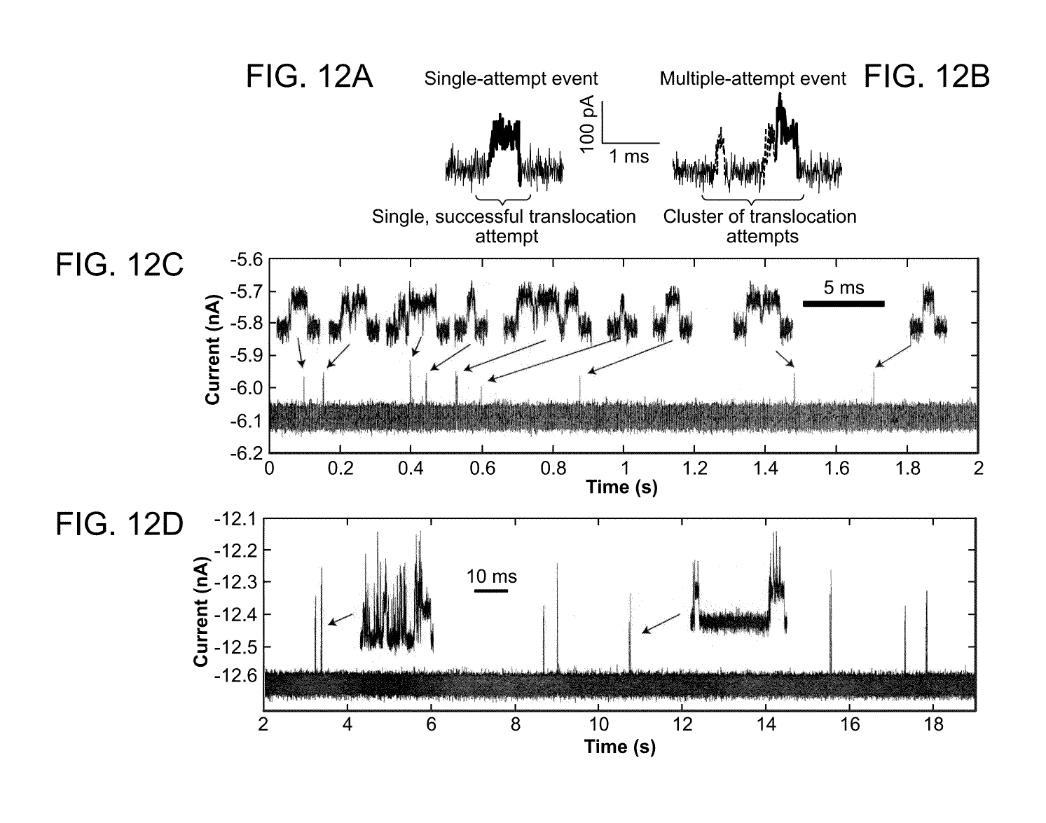

Representative ionic current traces for the nanopore system including 615 bp dsDNA at ΔP=2.06 atm and V=−100 mV are shown in FIGS. 12A-12B. The molecular event represented by the ionic current measurement in FIG. 12A is typical of a nanopore translocation event: the event is isolated and has a square shape with a single beginning and end. The ionic current measurement shown in FIG. 12B displays an unusual time structure in that after an initial sharp current blockage of short duration, the ionic current temporarily returned to the open-nanopore value before an ionic current blockade of similar duration. Other events are shown on an extended scale for 615 bp dsDNA at ΔP=1.76 atm and V=−100 mV in FIG. 12C. Corresponding data are shown for 3.27 kbp dsDNA with ΔP=0.865 atm and V=−100 mV in FIG. 12D.

Each “event” that caused a change in measured ionic current reflects the motion of a single molecule, as seen by comparing the short time scales of each event to the long time intervals between events. Individual excursions from the open-nanopore ionic current within each event represent the insertion of one end of the molecule into the nanopore in an “attempt” at translocation. A temporary return of the ionic current to its open-nanopore level corresponds to a failed translocation attempt, in which the molecule is expelled backwards from the nanopore to a trapped position near to the nanopore. If the return to the open-nanopore current is permanent, i.e., followed by no additional structure for an extended period such as the typical time between molecule captured (0.01˜10 sec), the attempt was successful or the molecule was lost from the trap by diffusion.

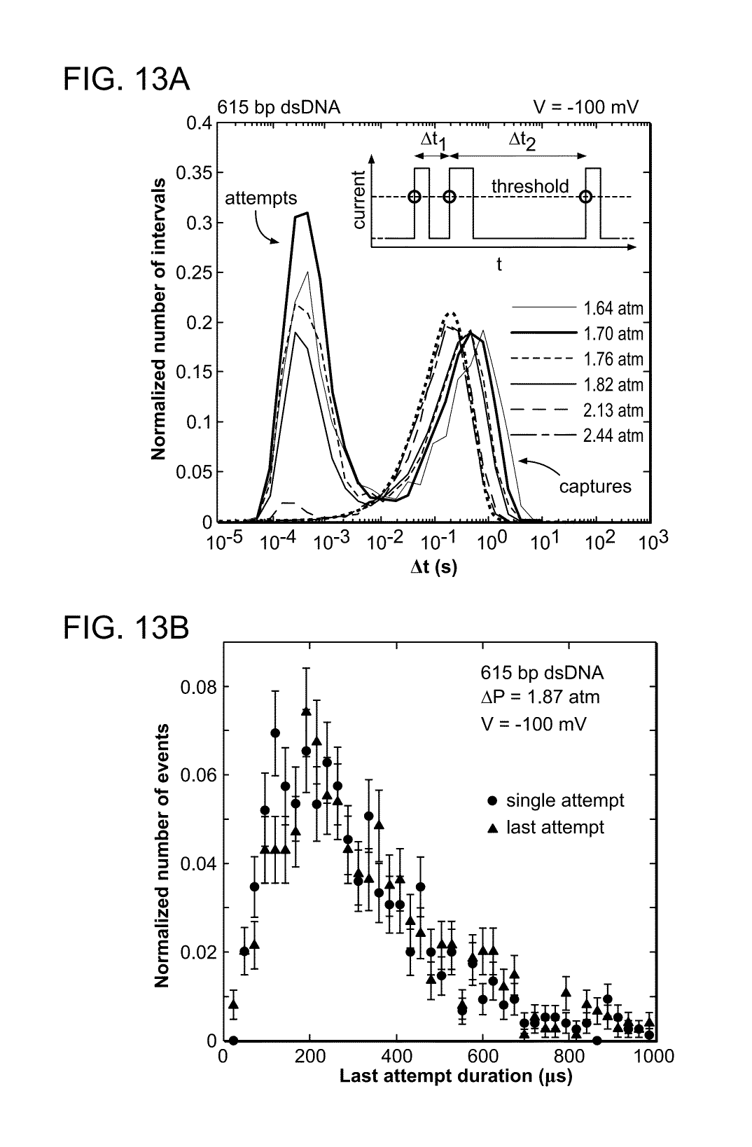

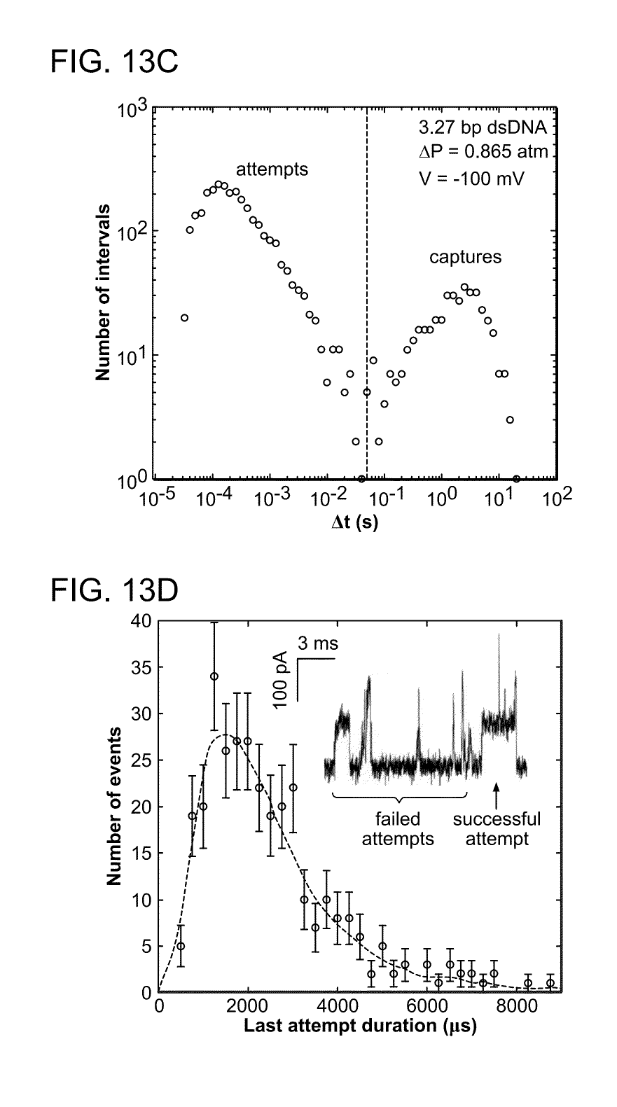

Inspection of the current traces shown in FIGS. 12A-D shows that the temporary returns to the open-nanopore current are much shorter than the time interval between individual events. To quantify this observation, herein is provided a threshold detection method. In the method, the ionic current trace is 5-sample median-filtered and compared to a threshold ionic current of 50 pA above the average open-nanopore current and about 70% of full ionic current blockage due to DNA translocation. The times at which the filtered current trace crosses the threshold are recorded. Each of these “threshold crossings” is categorized as “rising” or “falling” based on whether the ionic current is increasing or decreasing at the threshold crossing. Threshold crossings separated by less than 13 μs are indistinguishable from noise and are discarded. The time intervals, Δt, between rising threshold crossings are then computed, as shown in the inset to FIG. 13A. These time intervals are compiled into the “interval histograms” shown in FIG. 13A for 615 bp DNA for each pressure bias. A logarithmic scale is used for the histogram bins because the time intervals vary over orders of magnitude.

Each interval histogram is composed of two peaks, one at long intervals (0.1-10 s), and the other at short intervals (10⁻⁴-10⁻³ s). The peaks can be easily separated with a cutoff that varies with pressure, ranging between 1 ms for the highest pressures to 15 ms for the lowest. This shows that some of the rising threshold crossings occur in well-defined clusters. The long intervals correspond to the time elapsed between clusters, while the short intervals correspond to threshold crossings within clusters. The long intervals are Poisson distributed, shown as the heavy dashed line in FIG. 13A, and this peak is interpreted to be the distribution of intervals between the captures of different DNA molecules. Then each cluster represents the multiple probing of the nanopore by a single DNA molecule, and each rising threshold crossing within the cluster represents the beginning of a translocation “attempt,” i.e., the insertion of the molecule end into the nanopore. If a cluster contains multiple rising threshold crossings, it is referred to as a “multiple-attempt” event. Events with only one rising threshold crossing are “single-attempt” events.

FIG. 13B shows the event duration distributions for unfolded translocation events for 615 bp dsDNA at an external pressure of ΔP=1.87 atm and an applied voltage bias of V=−100 mV. Two distributions are shown: the event duration distributions of the single-attempt events and the last attempt of the multiple-attempt events. The two distributions are essentially indistinguishable, indicating that statistically the ultimate fate of molecules that produce single- and multiple-attempt events is the same. This interpretation is consistent with the inference that only the last attempt corresponds to translocation, and the prior attempts, i.e., the “all but last attempts,” correspond to failed attempts of the same molecule.

FIG. 13C shows the interval histogram for 3.27 kbp DNA for an external pressure ΔP=0.865 atm and an applied voltage V=−100 mV. The peak separation between attempts and captures occurs at about 50 ms (vertical dashed line). FIG. 13D shows the distribution of last attempt durations. The average translocation time was 2.6 ms, a factor of 24 greater than the translocation time for this length of molecule in a conventional voltage-driven translocation experiment at V=100 mV.

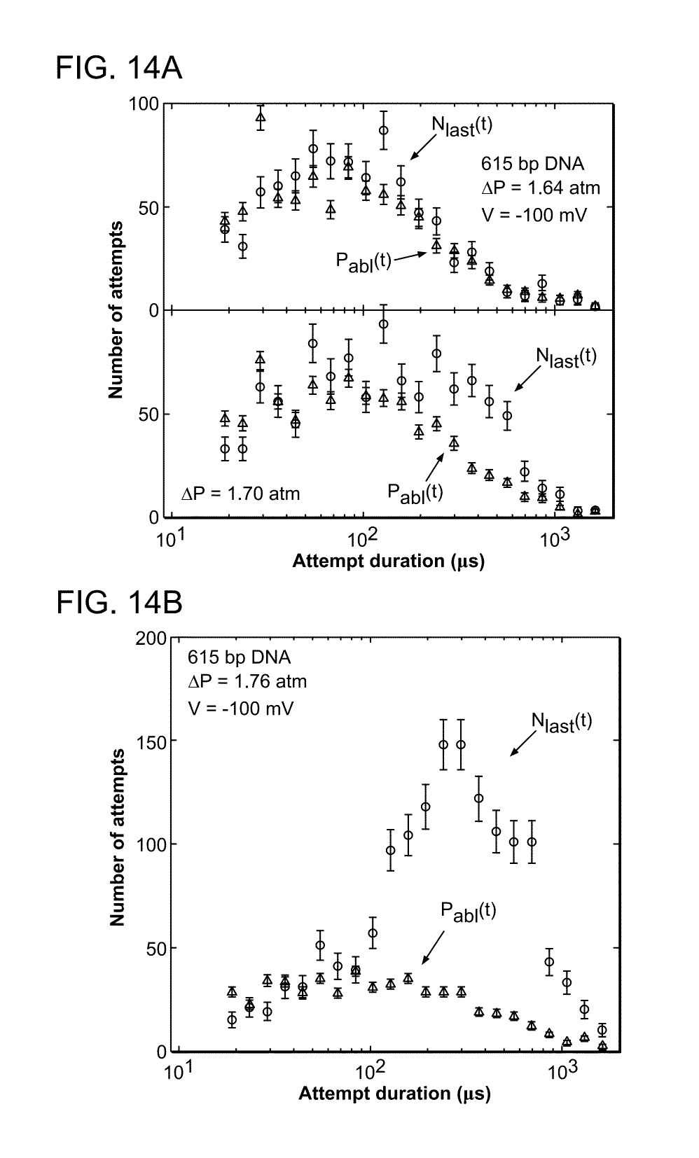

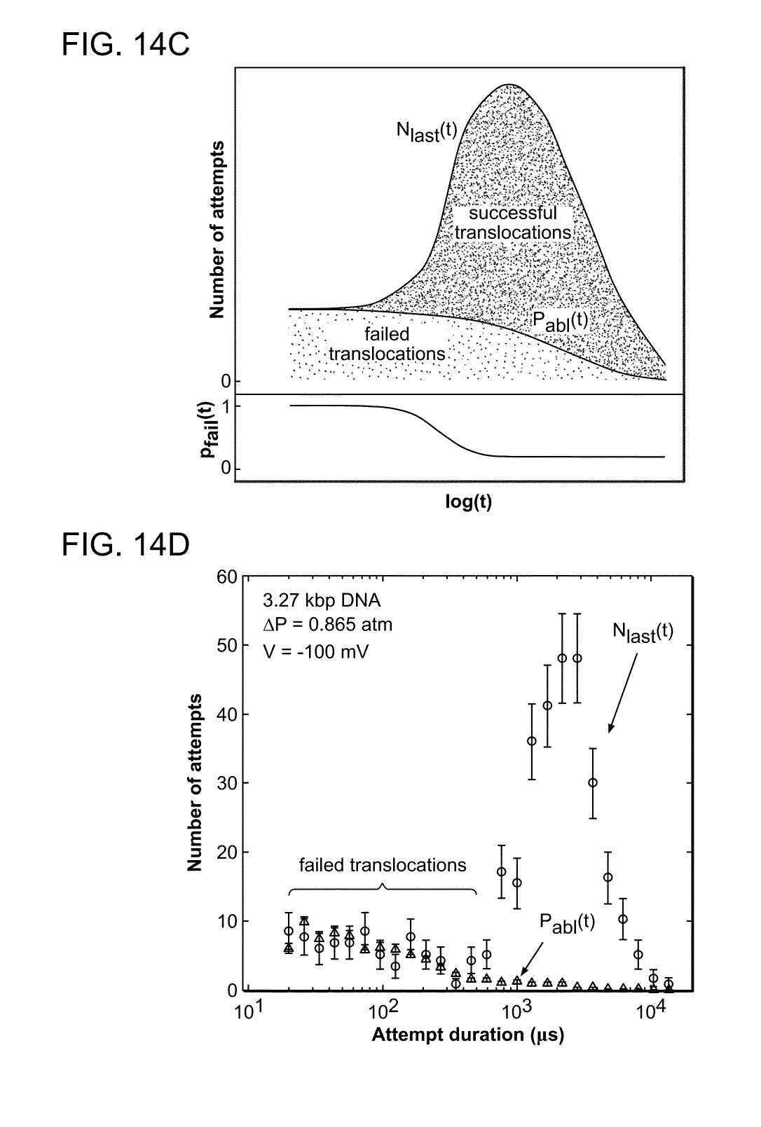

The existence of multiple-attempt events in the pressure-voltage-biased nanopore raises the question of whether or not all molecules that attempt to go through the nanopore ultimately succeed. In FIGS. 14A-B there is plotted the distribution Nₗₐₛₜ(t) of the “last attempt” duration t (both “single-attempt” and “multiple-attempt” events) for 615 bp DNA at ΔP=1.64, 1.70, and 1.76 atm. Also considered is the distribution of the durations of the “all but last attempts”, or N_{abl}(t). On the same axes as Nₗₐₛₜ(t), is plotted a scaled distribution P_{abl}(t)=N_{abl}(t)∫₀^{100 μs}Nₗₐₛₜ(t′)dt′/∫₀^{100 μs}N_{abl}(t′)dt′, where the integrals denote discrete sums over the distributions. At ΔP=1.64, Nₗₐₛₜ(t) and P_{abl}(t) are essentially indistinguishable. As ΔP increases, a clear peak in Nₗₐₛₜ(t) around 300 μs emerges that is not observed in P_{abl}(t).

The upper panel of FIG. 14C shows a schematic interpretation of these observations. If the duration of the last attempt is in the peak at 300 μs, it is likely to be a successful translocation attempt. The distribution of the durations of failed translocation attempts is indistinguishable from the distribution of the durations of failed attempts that occur before a successful translocation attempt. This accounts for the close correspondence in shape between Nₗₐₛₜ(t) and P_{abl}(t) at low pressures and for t<100 μs for the three pressures shown. It is assumed that such molecules are lost to diffusion or surface adhesion. The probability that a last attempt with duration t represents such a failed translocation is then given by p_{fall}(t)=P_{abl}(t)/Nₗₐₛₜ(t), as shown in the lower panel of FIG. 14C.

FIG. 14D shows the same analysis applied to the 3.27 kbp DNA data. Here the separation at about 500 μs between the failed and successful translocations is very clear. For this experiment, molecules that ultimately failed to translocate, i.e., were lost by diffusion, account for about 22% of the observed events, and they are excluded from the translocation time distribution shown in FIG. 14D.

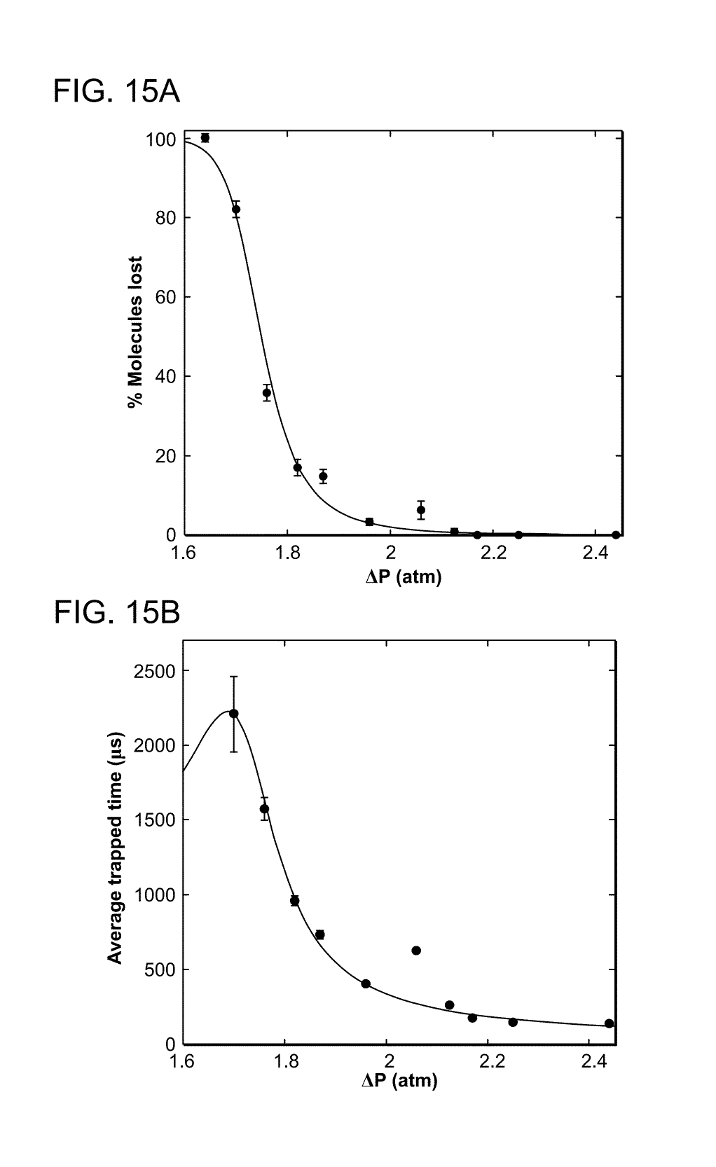

FIG. 15A plots the fraction of nanopore translocation attempts that failed, e.g., molecules that failed to translocate for the 615 bp dsDNA population at an applied counter voltage of V=−100 mV over the full range of experimental applied pressures ΔP. This value was directly calculated from the histograms in FIGS. 14A-B as ∫ₜP_{abl}(t) dt/∫ₜNₗₐₛₜ(t) dt. Error bars are calculated with the bootstrap method. At low ΔP the electrical force in the nanopore dominates, and all of the molecules eventually escape from the trap without translocating. At high ΔP viscous forces dominate, and the molecules translocate through the nanopore directly or stay in the trap until they translocate.

The average interval between the first and last observation of the molecule in the nanopore, that is, the average trapped time of successful translocation events, is plotted in FIG. 15B as a function of ΔP. From high to low ΔP the average trapped time was found to increase by over an order of magnitude. Because of the significant overlap between Nₗₐₛₜ(t) and P_{abl}(t), the probability of failed translocation p_{fall}(t) can be used, as in FIG. 14C, to select the successful events in a statistical fashion. For each event with last attempt duration, t, the event is deemed successful if a randomly chosen number between 0 and 1 is greater than p_{fall}(t). This procedure is combined with the bootstrap method to calculate the average trapped time for successful events, as shown in FIG. 15B. This demonstrates that a molecular trap of a finite time can be controllably implemented by applied external pressure and voltage bias at a nanopore.

The loss rate and trapping time can be understood in the context of a one-dimensional first passage approach. Here the 615 bp dsDNA is modeled in the P-V trap as a point particle diffusing in a force field that depends on ΔP and V. The pressure-derived forces Fₚ and voltage-derived forces F_{V} are not strongly coupled, allowing the net force to be written as F(x)=αFₚ(x)+βF_{V}(x)−k_{B}T/x. The force fields can be calculated by finite-element methods using a 200-nm long rod coaxial to the nanopore to model 615 bp dsDNA. The distance x from the nanopore is defined such that x=0 is the position where the front of the DNA molecule is in the center of the nanopore. The coefficients α and β are parameters that compensate for uncertainties in the geometry of the nanopore, the surface charge of the DNA and the nanopore, and the assumption that the molecule is coaxial with the pore. For example, we expect α≦0.5 because the average flow rate through a cylindrical pipe is about half that of the maximum. The final term in the expression for F(x) is an entropic force that arises from the collapse of three-dimensional diffusion outside the pore to one-dimensional diffusion. This term is only included when the molecule is outside the nanopore and is suppressed for x<0.

In a one-dimensional first-passage approach developed to describe the escape of dsDNA molecules from a diffusive trap, the distributions of escape times are defined as fₛ(x,t)dt and fₗ(x,t)dt to represent the probabilities, respectively, that the DNA passes through the pore successfully or is lost to diffusion within a time between t and t+dt given a starting position x. These probability functions obey an equation adjoint to the 1-D Smoluchowski equation as:

$$\frac{\partial {f}_{s , l} ( x , t )}{\partial t} = \frac{F ( x )}{γ} \frac{\partial {f}_{s , l} ( x , t )}{\partial x} + D \frac{{\partial }^{2} {f}_{s , l} ( x , t )}{\partial {x}^{2}} , \qquad ( 1 )$$

with boundary conditions

fₛ(−L,t)=δ(t); fₛ(x_{esc},t)=0; fₗ(−L,t)=0; fₗ(x_{esc},t)=δ(t) and initial values fₛ(x,0)=0 (x>−L); fₗ(x,0)=0 (x<x_{esc}). Here D and γ are the diffusion constant and drag coefficient, which are related through the fluctuation-dissipation theorem and are taken to be independent of position. L is the length of the DNA molecule, while x_{esc} is the position of the boundary at which the molecule is considered to be lost. The average trapped time of a successful translocation is given by τₛ(Δx)=∫₀^{+∞}tfₛ(Δx,t)dt, while the fraction of lost events is πₗ(Δx)=∫₀^{+∞}fₗ(Δx,t)dt, where Δx represents the offset in the initial position of the molecule from the condition where the front of the molecule is in the center of the nanopore. Because it is expected to observe full current blockage only when the molecule is inserted completely into the nanopore, this parameter is closely related to the pore length.

The first passage model is optimized using non-linear least squares regression with five free parameters: α, β, D, Δx, and x_{esc}. The optimized model prediction for πₗ and τₛ are shown as the solid curves in FIG. 4a-b** along with the values obtained from the 615 bp data as-described above. Note that the fit is quite good. The parameter values are α=0.382±0.003, β=0.261±0.002, D=10.6±0.5 μm²s⁻¹, Δx=−24±6 nm, and x_{esc}=445±26 nm. These are reasonable values; the diffusion constant in particular is in excellent agreement with the measurements of DNA diffusion under very small forces in nanopores. The small value of β suggests that the surface charge of the pore is large, about −120 mC/m². The escape radius corresponds to a center-of-mass position from the nanopore membrane of about 500 nm, which is half the average separation of 615 bp dsDNA molecules at the concentrations used in this experiment. It is therefore not surprising that this is the distance at which there is no distinction between molecules which have diffused away and other molecules which are newly captured in the P-V trap.

The success of this model in describing the observed trapping dynamics can be attributed in part to the choice of the relatively short 615 bp dsDNA that was used in the experiments, for three reasons. First, the molecule can be approximated by a point particle at relatively short distances from the pore. Second, the center of mass diffusion constant (relevant outside the nanopore) and the diffusion constant of the molecule inside the nanopore are approximately equal. Finally, the entropic cost to confine the molecule in the pore is minimal.

For longer molecules, it is much more difficult to write down the relevant force field. The transition from a three-dimensional center-of-mass picture to a one-dimensional length-wise diffusion picture takes place over a larger region outside the nanopore. Entropy, which figures prominently in models of the capture rate in voltage-biased nanopores, is likely to provide an additional barrier to insertion of the molecule in the nanopore. Finally, a position-dependent diffusion constant must be employed to further differentiate between center-of-mass and length-wise diffusion. Despite these modeling challenges, the method described herein can be adapted to model any selected molecular size, and is particularly advantageous for probing the roles of geometry and entropy in the capture of polymers into nanopores.

This example demonstrates that with a suitable combination of applied voltage and pressure it is possible create a single-molecule trap at the entrance to a nanopore. The lifetime of a molecule remaining in the trap is controlled by external pressure control and is well described by a first passage approach to a drift-diffusion model. This P-V trap enables the slowing of molecule translocation to the point where the fluctuating motion of a single molecule can be measured and studied.

The description and examples above demonstrate that with pressure and voltage control of a nanopore system, there can be decoupled the operation of an applied voltage as both a nanopore translocation force and a nanopore translocation detection transduction element. Pressure-induced hydrodynamic forces depend on the shape and size of a translocating species, not the electrical charge of the species. As a result, nanopores configured with both pressure and voltage bias control can characterize very small molecules, such as proteins, and species with very small electrical charges, as well as species in a variety of shapes as well as sizes. This wide ability contrasts with conventional voltage-biased nanopore systems, the operation of which has largely been limited to the study of electrically charged, large species, such as polymeric molecules. The pressure- and voltage-controlled nanopore system enables the study of a very broad spectrum of species, both solid state and biological, having a range of electrical charge and conformation. Thus, motion control and manipulation of even single species, such as single molecules, can now be accomplished reliably at positions close to or inside a nanopore.

It is recognized, of course, that those skilled in the art may make various modifications and additions to the embodiments described above without departing from the spirit and scope of the present contribution to the art. Accordingly, it is to be understood that the protection sought to be afforded hereby should be deemed to extend to the subject matter claims and all equivalents thereof fairly within the scope of the invention.

We claim:

1. A nanopore system comprising:
a nanopore in a support structure;
a first reservoir in fluidic connection with the nanopore;
a second reservoir in fluidic connection with the nanopore, with the support structure separating the first and second reservoirs;
a pressure source connected to one of the first and second reservoirs to apply an external pressure to one of the first and second reservoirs; and
a voltage source connected between the first and second reservoirs to apply a voltage bias between the first and second reservoirs, across the nanopore.

2. The nanopore system of claim 1 wherein the support structure comprises a solid state material.

3. The nanopore system of claim 2 wherein the support structure comprises a solid state material selected from the group consisting of oxides and nitrides.

4. The nanopore system of claim 2 wherein the support structure comprises an atomically thin solid state material selected from the group consisting of graphene and boron nitride.

5. The nanopore system of claim 2 wherein the support structure comprises a free standing membrane that is supported at edges of the membrane by a support frame.

6. The nanopore system of claim 1 wherein the nanopore comprises a biological nanopore.

7. The nanopore system of claim 6 wherein the nanopore comprises a biological nanopore selected from the group consisting of alpha-hemolysin, MspA and Aerolysin.

8. The nanopore system of claim 6 wherein the nanopore comprises a lipid bilayer.

9. The nanopore system of claim 1 wherein the nanopore comprises a biological nanopore and the support structure comprises a solid state material.

10. The nanopore system of claim 1 wherein the pressure source comprises a connection to a gaseous pressure source including at least one of gaseous nitrogen and gaseous oxygen.

11. The nanopore system of claim 1 further comprising a pressure monitor connected to reservoir to which the pressure source is connected, to measure pressure in that reservoir.

12. The nanopore system of claim 1 wherein the nanopore has a diameter that is between about 1 nm and about 5 nm.

13. The nanopore system of claim 1 wherein the nanopore has a diameter that is less than about 100 nm.

14. The nanopore system of claim 1 wherein the nanopore has a diameter that is between about 10 nm and about 20 nm.

15. The nanopore system of claim 1 further comprising an electrical circuit connecting the voltage source to an electrode in the first reservoir and an electrode in the second reservoir.

16. The nanopore system of claim 15 further comprising an electrical current monitor connected in the circuit to measure current flow through the nanopore.

17. The nanopore system of claim 1 wherein the first reservoir is configured to provide to the first port of the nanopore a species in a fluidic solution.

18. The nanopore system of claim 17 wherein the pressure source is connected to the first reservoir to apply an external pressure to the first reservoir to cause nanopore translocation of species in the fluidic solution in the first reservoir.

19. The nanopore system of claim 18 wherein the pressure source is connected to the first reservoir to apply an external pressure, to the first reservoir, that is of sufficient pressure magnitude to cause nanopore translocation of species in the first reservoir.

20. The nanopore system of claim 19 wherein the voltage source is configured in a circuit to apply a voltage bias between the first and second reservoirs, across the nanopore, with a voltage polarity that opposes the external pressure in the first reservoir.

21. The nanopore system of claim 17 wherein the first reservoir is configured to provide to the nanopore a fluidic solution including at least one of molecules and molecular components.

22. The nanopore system of claim 17 wherein the first reservoir is configured to provide to the nanopore a fluidic solution including biomolecular species.

23. The nanopore system of claim 17 wherein the first reservoir is configured to provide to the nanopore a fluidic solution including at least one of DNA molecules, RNA molecules, PNA molecules, oligonucleotides, nucleotides, and proteins.

24. The nanopore system of claim 17 wherein the fluidic solution comprises an electrolytic solution.

25. A nanopore system comprising:
a nanopore in a support structure;
a first reservoir in fluidic connection with the nanopore, the first reservoir including a fluidic solution comprising a species for translocation through the nanopore;
a second reservoir in fluidic connection with the nanopore, the second reservoir including the fluidic solution, the support structure separating the first and second reservoirs;
a pressure source connected to the first reservoir to apply to the first reservoir an external pressure that is sufficiently large to cause the species in the first reservoir to translocate through the nanopore; and
a voltage source connected between the first and second reservoirs with a voltage polarity that opposes the external pressure applied to the first reservoir.

26. A method for analysis of species in solution comprising:
providing to a nanopore in a support structure a fluidic solution that includes a species for translocation through the nanopore;
applying to the species in fluidic solution an external pressure; and
applying across the nanopore an electrical voltage bias that produces an electric field across the nanopore.

27. The method of claim 26 wherein applying an external pressure comprises applying a pressure magnitude sufficient to cause nanopore translocation of the species in fluidic solution; and where applying an electrical voltage bias comprises applying a voltage bias set at a voltage magnitude that slows translocation of species through the nanopore.

28. The method of claim 26 wherein applying an electrical voltage bias comprises applying a voltage bias set at a voltage magnitude that balances the applied external pressure to disallow translocation of species through the nanopore, physically trapping the species at the nanopore.

29. The method of claim 26 wherein applying an electrical voltage bias comprises controlling the voltage bias with a temporal sequence of voltage magnitudes, the sequence of voltage magnitudes including a first voltage magnitude that balances the external pressure to physically trap the species at the nanopore, a second voltage magnitude that causes translocation of species through the nanopore, and a third voltage magnitude, with a reversal of voltage polarity, that causes translocation of species through the nanopore.

30. The method of claim 26 wherein applying an external pressure comprises applying an external pressure of between about 1 atm and about 3 atm.

31. The method of claim 26 wherein the support structure comprises a solid state material.

32. The method of claim 26 wherein the nanopore comprises a biological nanopore.

33. The method of claim 32 wherein the nanopore comprises a biological nanopore and the support structure comprises a solid state material.

34. The method of claim 26 wherein the species in fluidic solution comprises at least one biomolecular species.

35. The method of claim 26 wherein the species in fluidic solution comprises at least one of DNA molecules, RNA molecules, PNA molecules, oligonucleotides, nucleotides, and proteins.

36. The method of claim 26 further comprising detecting nanopore translocation of species in fluidic solution.

37. The method of claim 36 wherein detecting nanopore translocation comprises measuring ionic current flow through the nanopore.
